(19) United States
(12) Patent Application Publication
(10) Pub. No.: US 2009/0199192 A1
(43) Pub. Date: Aug. 6, 2009

(54) Resource scheduling apparatus and method

(76) Inventors: Robert Laithwaite, Ipswich (GB); Brian Fletcher, Felixstowe (GB); Guy Johnson, Ipswich (GB)

Correspondence Address: WAGNER BLECHER LLP, 123 WESTRIDGE DRIVE, WATSONVILLE, CA, 95076, US

(21) Appl. No.: 12/012,805

(22) Filed: Feb. 5, 2008

(51) Int. Cl. G06F 9/50

(52) U.S. Cl. 718/104

(57) ABSTRACT

Embodiments of the invention are concerned with allocating resources to tasks and have particular application to situations where the availability of resources and the tasks to be performed change dynamically and the resources are mobile.

When dealing with a mobile resource such as a field technician, typically a series of tasks, known for example as a “tour” of tasks, is allocated to the resource. A known factor in scheduling tasks in a tour is travel time between tasks, and as a result the geographical position of the tasks can be a factor in building a tour. If a resource reports in and the scheduling system adjusts the provisional schedule, for example by adding one or more tasks to a tour, those tasks will be chosen at least in part with regard to the geographical location of the resource and that of existing tasks in the tour. This assessment is conventionally performed on the basis of the coordinates of the task completed by the resource (which are fixed), and is adequate when the resource is physically present at the task location when he reports in. However, in practice, a resource may not be at the expected geographical location of the last task dealt with. For example, a telephone technician may go back to the telephone exchange before reporting in; in such a situation, any decisions as regards adjustment of the schedule may be based on inaccurate data and result in a degenerative modification to the schedule.

Embodiments of the invention utilise a selection criterion that enables actual location data to be used for scheduling of future work: this selection criterion is associated with the status of the resource in relation to progress with a given task, and can most appropriately be identified on the basis of whether or not the resource has completed a task. An advantage of basing the use of actual location data on this criterion is that the state of the resource is relatively stable in relation to various anchor points in the schedule when a task has been completed. As a result a point that is known with some confidence in the schedule can be mapped to the present location of the resource.

### FIELD OF THE INVENTION

This invention relates to a method for allocating of resources to tasks, and to a computer-implemented system for executing such a method. It is particularly suited for use in situations where the availability of resources and the tasks to be performed change dynamically and the resources are mobile.

### BACKGROUND

An example of a situation in which characteristics or resource and task requirements can change dynamically is the allocation of tasks to resources such as a field force of personnel, for example ambulance or taxi drivers, a vehicle repair call-out field force, or a maintenance field force for a distributed system such as an electricity or water supply system or a telecommunications network. In such situations the workload can be highly variable and volatile, and tasks have to be allocated in real-time since the necessary response times are of the order of the duration of the tasks themselves, and very much shorter than a resource's working day. The durations of the individual tasks are themselves very variable and often unpredictable, which affects resource availability for those tasks awaiting allocation.

A prior art system, described in U.S. Pat. No. 6,578,005, deals with allocating field technicians (“resources”) to tasks. It calculates a provisional schedule for each resource, but allows changes to these schedules if a resource reports task completion early, or fails to report at the estimated time, or if new tasks are requested after the provisional schedule has been created. There are two systems which run independently, an offline system and an on-line (real-time) system, although the output of the off-line system is used as the starting point for the operation of the on-line (real-time) system. The offline system might for example run overnight and it generates then optimises a schedule of tasks, provisionally allocated to the resources. The on-line system takes as input the provisional schedule of the offline system and adjusts it in accordance with real-time information gathered in registers. The on-line system has an allocation processor which uses current status information in the registers, for example regarding late resources or cancelled tasks, to generate an adjusted allocation for a resource when he/she comes on-line to request instructions.

The on-line system is there to ensure that the provisional schedules produced for example in time for the beginning of the working day can respond to events occurring during the day. Such events might include for example resources reporting in for new tasks earlier or later than expected, absences requested at short notice, changes to a scheduled task (e.g. an amended appointment), new tasks entering the system, or changes to the scheduling and allocation rules or evaluation cost criteria, such as a change to travel times to account for adverse weather or traffic conditions. The objective is to make sure that when a resource requests a task, the task actually allocated is the most suitable task available for that resource at the time the request for work is dealt with, whether or not it is the one originally scheduled.

When dealing with a mobile resource such as a field technician, typically a series of tasks, known for example as a “tour” of tasks, is allocated to the resource. A known factor in scheduling tasks in a tour is travel time between tasks, and as a result the geographical position of the tasks can be a factor in building a tour. If a resource reports in and the scheduling system adjusts the provisional schedule, for example by adding one or more tasks to a tour, those tasks will be chosen at least in part with regard to the geographical location of the resource and that of existing tasks in the tour. This assessment is conventionally performed on the basis of the coordinates of the task completed by the resource (which are fixed), and is adequate when the resource is physically present at the task location when he reports in. However, in practice, a resource may not be at the expected geographical location of the last task dealt with. For example, a telephone technician may go back to the telephone exchange before reporting in; in such a situation, any decisions as regards adjustment of the schedule may be based on inaccurate data and result in a degenerative modification to the schedule.

It is known to use real-time position measuring systems to track the position of a mobile resource. Such systems include terrestrial networks of transmitters (e.g. Loran) and networks of satellites (e.g. GPS (“Global Positioning Satellite”), Galileo, GLONASS (“Global Navigation Satellite System”)) deployed specifically for the purpose of locating the receiver, as well as methods that use general-purpose radio networks such as cellular mobile telephone networks (e.g. WO97/11384) or radio transmitter networks (e.g. EP0303371). Other systems use a combination of satellite and radio network technologies, such as is described in WO2005/071430.

Real-time positioning information can be used in many different circumstances: for instance, in US patent application having publication number US2006/0142913 (Concrete Mixers), GPS location data of a resource is used for vehicle operation checks and in U.S. Pat. No. 6,947,881 (Electric Car Hire), GPS location data of a resource is used to allocate mobile resources (that is, cars are allocated to people). In US patent application having publication number US2004/0064225 (Loco Servicing), detection occurs if a piece of mobile equipment remains at a location for too long an interval, as determined by GPS. For example, a locomotive of a train may be remaining in repair longer than expected, in which case notice is given that there is a risk of utilisation loss in relation to the locomotive and action can be taken to hurry the repair process.

There are however many potential difficulties in using the real-time location of resources as a factor in real-time scheduling, or re-scheduling, of resources. For example, one option is to track the location of resources at all times. However, if the location data is being used for calculating travel time as a factor in task allocation, then it must be borne in mind that real-time location data is only relevant to the device performing the location measurements. If a resource is not with their vehicle for instance, the effect on travel time can be significant because he/she will have to walk to the vehicle. This might be the case for example where the resource is present on a large site or where local parking has not been available.

The use of real-time location data for tracking resources is an attractive option where there is flexibility in allocated tours because the resource can (and in practice often does) vary the order in which the tasks in the tour are performed; as a result, once a tour has been issued, the location of the resource can be unpredictable, and this makes it difficult to determine how and to which resource, an urgent task should be allocated.

Various terms are used in the specification to describe different aspects of the scheduling and issuing of tasks to resources; for convenience a discussion of these terms is set out below.

Allocate tasks: To commit tasks and/or tours that have already been scheduled and optimised to one or more resources for execution. Thus up to the moment that a resource comes on-line to the system the choice of which tasks to allocate based on the schedule and potentially other newly arrived or important unscheduled tasks can be adjusted. Allocated tasks are then issued to individual resources when each resource is connected to the system.
Deallocate tasks: To revoke the decision that a resource shall execute a task or tour of tasks as previously allocated.
Issue tasks: To notify a resource, usually on-line, that he shall perform an allocated task or tour of tasks and pass the task details to the resource. In practice, this means transferring data concerning the task from a server to client software present on a device operated by the resource using any suitable communications system such as a fixed or mobile telephone network or local area network (“LAN”).
Execute tasks: For a resource to perform an issued task, that is, both to travel to a suitable location and to do the work the task requires. This may involve the resource taking his vehicle and its GPS equipment away from the location of the task to other locations to do the work, for example at the exchange, or the resource leaving his vehicle and its GPS equipment some distance from the location of the task.
Close a Task: For a resource to notify that he has completed execution of a task. Closure of a task may or may not occur at the location of the task.
Schedule tasks: To produce, based on business optimization, a plan comprising a specified set of allocated tasks and/or tours of tasks, to be performed at specified times and distributed (within the plan) against a specified set of resources.
Optimise tasks: To adjust the order and resource assignment of tasks or tours in a schedule to improve efficiency, for example by reducing travel time.
Repair a schedule: To allocate a task, for a resource closing a task, who has no next scheduled task or no valid scheduled task on the basis of an existing schedule. This might be for example because a task has turned out to be not possible, for example the next task was cancelled or infeasible due to arrival time because the resource completed one or more tasks early or late or because the resource is not in an expected location.
Park: For a resource to indicate via automatic sensors in his vehicle, that he has arrived at a location suitable for a task and parked the vehicle (switched the ignition off) which if close to a target destination indicates that they have arrived.
Inject or Insert into a Tour: To add a task to a tour subsequent to the issuing of the tour to the resource. This assumes the resource is unavailable until a current executing task is completed. The resource is instructed (for example by pager or SMS message) to interact (usually to come on-line) so as to be issued with another task in their current tour or could be ‘pushed’ the task if already connected via an ‘always-on’ communication mechanism.
Interrupt: To instruct (for example by pager or SMS message) a resource to pause or delay any issued task he is executing or travelling to, and to interact (usually to come on-line) so as to be issued with another task or tour of tasks.

### SUMMARY OF THE INVENTION

In accordance with at least one embodiment of the invention, methods, systems and software are provided for supporting or implementing functionality to provide scheduling of resources using real time location data, as specified in the independent claims. This is achieved by a combination of features recited in each independent claim. Accordingly, dependent claims prescribe further detailed implementations of the present invention.

As will be appreciated from the background section, resource scheduling involves a significant number of inputs. In relation particularly to real-time location data, this information can be used to improve estimates of journey times and keep a track of what resources are doing at any given time; thus at first sight it would appear relatively clear that location data is always useful to the scheduling process. However, simply using current location data at every opportunity during scheduling and real-time task allocating processes brings significant computational problems. Moreover, in order to generate a schedule within a time frame that is suitable for the operating environment and that is stable involves judicious selection of the inputs available; this selection issue is particularly acute in relation to inputs that inherently vary continuously throughout the day, such as the location of a mobile workforce.

Accordingly, it will be appreciated that identification of such selection criteria and/or circumstances in which it is appropriate to use actual location data is a non-trivial task, particularly given that the obvious starting point described above, which involves using always a current position to schedule future work, incurs an unmanageable number of updates to the schedule, and thus introduces instabilities that can outweigh the benefits expected from using location data. As a result it appears that real time position data is suitable for allocation only, and is not suitable for use in the scheduling of future work.

According to a first aspect of the present invention, there is provided a task-allocation method of generating a schedule, the schedule comprising a plurality of tasks to be performed by a plurality of resources, at least some said resources having a plurality of allocated tasks associated therewith, the method comprising:

receiving data relating to the tasks to be performed and resources for allocating to said tasks;

receiving status data relating to tasks that have been issued to at least some of the resources;

receiving location data of a first type, said location data of the first type being a predetermined location;

receiving location data of a second type, said location of a second type including an actual location of a resource;

allocating resources to the tasks on the basis of location data of the first type or the second type;

in which the resources are selectively allocated to the tasks using the location of the second type in dependence on status data indicating completion of an allocated task.

Thus embodiments of the invention utilise a selection criterion that enables actual location data to be used for scheduling of future work: this selection criterion is associated with the status of the resource in relation to progress with a given task, and can most appropriately be identified on the basis of whether or not the resource has completed a task. An advantage of basing the use of actual location data on this criterion is that the state of the resource is relatively stable in relation to various anchor points in the schedule when a task has been completed. As a result a point that is known with some confidence in the schedule can be mapped to the present location of the resource. Preferably the actual location is used in relation to a completed task location at the end of a tour of tasks, this being derivable from the status data. Additionally, the status of the vehicle accompanying the resource can be used to determine whether or not the resource has completed the task; for example, if the vehicle status data indicates that the vehicle is stationary and engine switched off, this can be taken as an indication that the resource is not in the process of moving to another task.

In one arrangement both the vehicle status and resource/task status are used to determine whether or not to use actual location data in the schedule generation process. In the event that the actual location data is provided by a GPS system, this has the benefit of avoiding using the GPS location of a moving vehicle, and makes use of the observation that an appropriate time to substitute GPS location data for task location data by the tour construction system is while a resource is executing the last of the tasks that had been issued to them (i.e. all other tasks that had been issued to them have been completed) and the status of the relevant vehicle V is “parked”. This is an “appropriate time” because the GPS location data will be stable and the starting point for scheduling a next task to the resource will be based on accurate locations of the resource in a greater number of instances. It will be appreciated that positioning measurement systems other than GPS can be used to obtain the actual location of a resource, these including other satellite systems or terrestrial positioning systems, and examples of such alternatives are described in more detail towards the end of the specification.

In general, the location of the first type is a static location relating to e.g. a customer's premise, an exchange, a congregating area, and the like. In one arrangement, the actual location data are combined with the static location data in order to generate an interpolated location, and the schedules are generated on the basis of the interpolated location. This approach is most conveniently taken in respect of the static location of a previous task completed by the resource so as to tie schedule changes as closely as possible to criteria used to previously allocate tasks to a given resource. In another arrangement, the actual location data can be used to determine a location of the first type (i.e. static location relating to a building or the like), and confidence in this location being a useful location input can be improved by reviewing actual location data relating to several resources, particularly when the GPS data overlaps with a static location relating to a site where resources are known to congregate.

In embodiments of the invention, the location of the second type (i.e. actual location) is preferably compared with the location of the first type (i.e. static location such as customers' premises) associated with a previously executed task for the resource so as to determine a variance in expected location. In the event that the variance exceeds a predetermined threshold, tasks situated within a predetermined distance from the actual location of the resource are then identified. These tasks—referred to as candidate tasks—can be evaluated against a cost function so as to determine whether or not to replace the next task in the plurality of tasks allocated to the resource with a said identified task. Alternatively these tasks can be identified on the basis of respective priority status associated therewith so as to determine whether or not to replace the next task in the plurality of tasks allocated to the resource with a said identified task. The candidate tasks can be scheduled tasks, that is to say tasks that have already been associated to a resource, or tasks newly introduced to the system and thus unscheduled. In preferred embodiments, decisions in relation to comparisons between respective priority status can be implemented by means of thresholds, which is to say that unless the difference between resource location data and task location data is above a given threshold, no action need be taken to update the schedule. By providing configurable thresholds, embodiments of the invention provide a convenient mechanism for modifying the schedules to account for actual location in carefully bounded situations. As a result any modifications that are made to the schedules result in stable schedule propagation.

In addition, or as an alternative, to using the actual location data to generate and/or modify schedules comprising allocated tasks, the actual location data can be used to revise start times of allocated tasks: since each said allocated task has a start time associated therewith, the method can involve using the location of the second type to re-evaluate travel time to a next task in the plurality of allocated tasks and adjust the start time of the next task in the event that the evaluated travel time is different to the previously evaluated magnitude.

As mentioned above, the actual location of a resource can be derived from a Global Positioning Satellite (GPS) system associated with a resource, either as a feed to a terminal used by the resource or part of a GPS system associated with the vehicle.

The afore-mentioned steps can be performed in respect of schedules where the status data are received asynchronously or synchronously with respect to the actual allocation of tasks. This means that real time position data can be used by scheduling systems that run periodically and/or that are triggered by real time events such as a resource reporting in, a task failing, or a change to task status. Additionally, embodiments of the invention can be arranged to monitor location data of the second type against an expected location for at least one of the plurality of resources, in which case the method can be triggered when the current actual location deviates from the expected location by more than a predetermined amount.

In a further aspect of the invention, there is provided a method of issuing an unissued task to a resource, the resource having a plurality of allocated tasks associated therewith, at least some of said plurality of allocated tasks being stored as a sequence of issued tasks in a storage system, the storage system holding location data indicative of an actual location of the resource, the method comprising:

reviewing task data indicative of tasks that are either scheduled or unscheduled and have not been issued to a resource so as to identify, from said task data, a task of a first type;

identifying a location of the identified task of a first type;

accessing the storage system so as to select at least one resource from a plurality of resources on the basis of a concordance between the identified task location and the actual location of respective ones of said plurality of resources;

issuing the identified task to the selected resource; and

updating the storage system to include the issued task for the selected resource

This aspect of the invention provides a mechanism for injecting tasks into a tour of tasks already issued to a resource, and is particularly useful in situations where a tour has been modified, e.g. to remove a previously issued task due to cancellation of a task in the tour, leaving a gap in the tour. In this aspect of the invention, actual location data can be used for selection of a suitable task to insert into the newly opened gap in the tour. Further, in this aspect of the invention the use of actual location data is not contingent on the resource having completed a task, since it is essentially triggered by a change to a tour and is evaluated on a per-resource basis, rather than being part of the overall scheduling process.

In a yet further aspect of the invention there is provided a method of modifying a schedule of tasks allocated to a resource, the schedule comprising a list of tasks comprising a plurality of tasks to be used to determine a sequence of tasks to be performed by the resource, the method comprising:

receiving data from a location measurement device associated with the resource, whereby to receive the actual location of the resource;

identifying, from a pool of scheduled and unscheduled tasks, a candidate task on the basis of location data associated with respective scheduled and unscheduled tasks and the actual location of the resource;

evaluating the identified task in relation to a next task associated with the resource in the schedule so as to select a task therefrom; and

issuing the selected task to the resource, whereby to modify the schedule of tasks.

This aspect of the invention provides a mechanism for interrupting a tour of tasks already issued to a resource, and is particularly useful in situations where the threshold controls mentioned above militate against modifying a schedule, yet a task of high priority has been received and needs to be scheduled before the next periodic schedule run. In further aspects, there is provided a distributed system for performing the afore-mentioned steps. The method can be executed as a set of processable instructions on a suitably programmed computer system in operative association with a storage, or database, system.

It will be appreciated that use of location data according to embodiments of the invention provides a scalable mechanism for scheduling of resources to tasks. Further, embodiments of the invention offer a significant improvement, in terms of cost and certainty of task completion, over conventional systems, since these predominantly factor in actual location data on an ad hoc (per task) basis and have little, if no, regard for the effects of these ad hoc schemes on other tasks in the schedule.

In the following description the term “pending” is used to characterise tasks; this is to be understood as indicating the scheduling status of an activity (e.g. task, absence, break) which is scheduled for a resource but not yet issued, and for which the information on which the schedule was based is assumed to be still valid.

### BRIEF DESCRIPTION OF THE FIGURES

A resource scheduling system for scheduling a team of network engineers as resources to do tasks in relation to maintaining network and communications services will now be described as an embodiment of the present invention, by way of example only, with reference to the accompanying figures in which:

FIG. 1 shows a general arrangement of a system including a computer system, configured to operate according to the invention;

FIG. 2 shows the components of the computer system of FIG. 1;

FIG. 3 is a functional block diagram of the resource scheduling system installed on computer system of FIG. 1 for initial schedule generation, optimisation and real time allocation of tasks;

FIG. 4 shows data structures of a database for use in the system of FIG. 3;

FIG. 5 shows a prioritised task pool that might be searchable in the database of FIG. 4, including various thresholds;

FIG. 6 is a schematic flow diagram showing operation of the resource scheduling system of FIG. 3;

FIG. 7 is a schematic flow diagram showing use of real time location data by the resource scheduling system of FIG. 3 according to an embodiment of the invention;

FIG. 8 is a schematic flow diagram showing use of the resource scheduling system of FIG. 3 to inject tasks on the basis of real time location data;

FIG. 9 is a schematic flow diagram showing use of the resource scheduling system of FIG. 3 to insert tasks into a tour on the basis of real time location data;

FIG. 10 shows a functional block diagram of a real time task allocator for use in the resource scheduling system of FIG. 3;

FIGS. 11, 12 and 13 show schematic scenarios in which GPS location data might be relevant in operation of the allocator of FIG. 10;

FIG. 14 shows a prioritised pool of un-issued tasks which might be used in real-time task allocation, including use of interrupt and inject scheduling as well as use of the allocator of FIG. 10; and

FIG. 15 schematic flow diagram illustrating the operation of the allocator of FIG. 10.

Several parts and components of the invention appear in more than one Figure; for the sake of clarity the same reference numeral will be used to refer to the same part and component in all of the Figures. In addition, certain parts are referenced by means of a number and one or more suffixes, indicating that the part comprises a sequence of elements (each suffix indicating an individual element in the sequence). For clarity, when there is a reference to the sequence per se the suffix is omitted, but when there is a reference to individual elements within the sequence the suffix is included.

### DETAILED DESCRIPTION

As described above, embodiments of the invention are concerned with utilising actual location data, which may be derived from a positioning system, when generating schedules. Details of the infrastructure, algorithms and implementation will be described in detail below, but first the task scheduling problem domain within which embodiments of the invention operate will be presented.

### General Principles of Task Scheduling

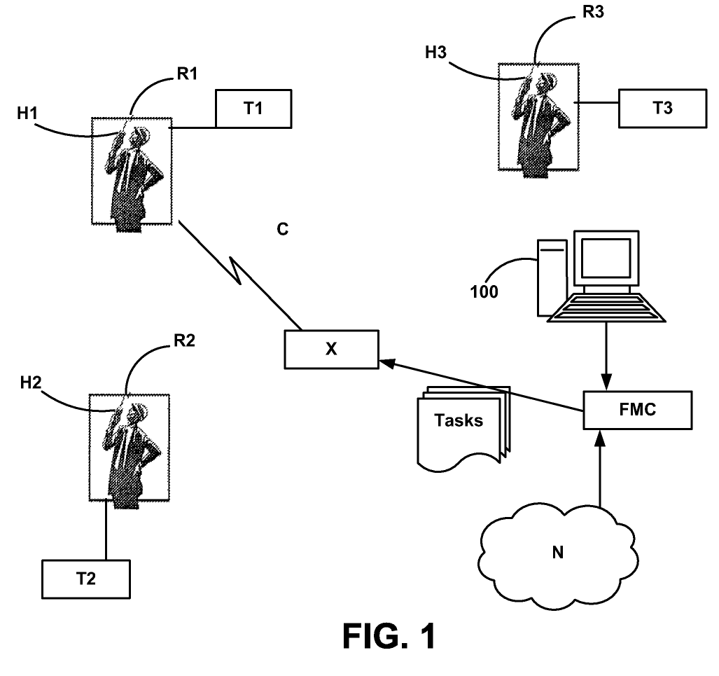

Referring to FIG. 1, there is shown a telecommunications system N which is monitored by a fault-monitoring system FMC. The fault monitoring system FMC detects faults in the network N which require attention, and also receives inputs from a network management system 100, originated for example by a human operator or an automated system, for example to schedule planned maintenance or to generate task (or “job”) requests to be performed by a field force of technicians (“resources”) R1, R2, R3. The task requests are input to a resource allocation computer system for allocating resources to tasks, which can communicate through the telecommunications network N with hand-held terminals H1, H2, H3, as required. As shown in FIG. 1, terminal H1 is currently in communication with the computer system through a connection C. Each of the hand-held terminals may a laptop or PDA or smart phone, but other suitable equipment may be used.

The resource allocation system initially schedules tasks by putting them together into “tours” T1, T2, T3, based on geographical location of the tasks as well as urgency and other criteria, and these tours T1, T2, T3 are allocated to resources R1, R2, R3, in this case the technicians. The use of tours firstly gives the resources more information about their working day when they start in the morning and secondly allows them a degree of flexibility as the resource can decide for example to execute the tasks in a given tour in any preferred order. Tours are issued to the resources R1, R2, R3 who will then execute them. The resources will call in to the resource allocation system on the computer at various times, for example because they have closed an allocated task of a tour or to request or notify some change. Various situations will arise in real time that necessitate change. For example, urgent tasks might arise or tasks in issued tours might be cancelled so that the resource calls in early to find out what to do next. The resource's vehicle might suffer a breakdown. The resource allocation system runs subsequent processes throughout the day to deal with these real time situations.

In a real situation there will be many resources R1, R2, R3 (typically a few hundred) and many more tasks. Typically a workforce of one hundred resources might perform six hundred tasks in one day. Some of these are known at the beginning of a working day but, in a typical day, several hundred tasks will be added to the system, scheduled initially as tours T1, T2, T3, and removed after completion. All the new tasks, and a proportion of the completions, will be reflected in the day's programme. Thus, although each individual resource's schedule may only change once or twice a day, or potentially not at all once the tour(s) have been allocated, changes to the day's programme will have to be made very roughly every couple of minutes or less during an eight hour working day.

For illustrative purposes the present example has just three resources R1, R2, R3 who are provided, respectively, with the terminals H1, H2, H3. The resources R1, R2, R3 are presently engaged on tours T1, T2, T3 and there will be further tasks awaiting attention. The resources R1, R2, R3 can use their terminals H1, H2, H3 for reporting completion of a tour and/or individual tasks and for receiving instructions from resource allocation system.

For illustrative purposes, the three resources R1, R2, R3 may be considered as part of a field force for performing tasks on the telecommunications network N. However, the system to be monitored need not be a telecommunications system, and may be quite separate from the telecommunications system through which the terminals communicate with the resource allocation system.

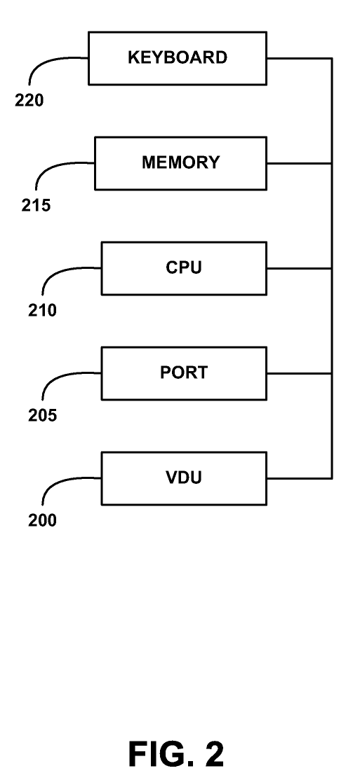

Referring to FIG. 2, the basic components of a computer system configured to implement the resource allocation system comprise a keyboard 220, a central processing unit (CPU) 210, a visual display unit (VDU) 200, a memory 215 and an input/output port 205. The data and the programs for controlling the resource allocation system are stored in memory 215. The input/output port 205 connects the computer to the telecommunications system which provides the communication links between the computer and the hand held terminals H1, H2, H3.

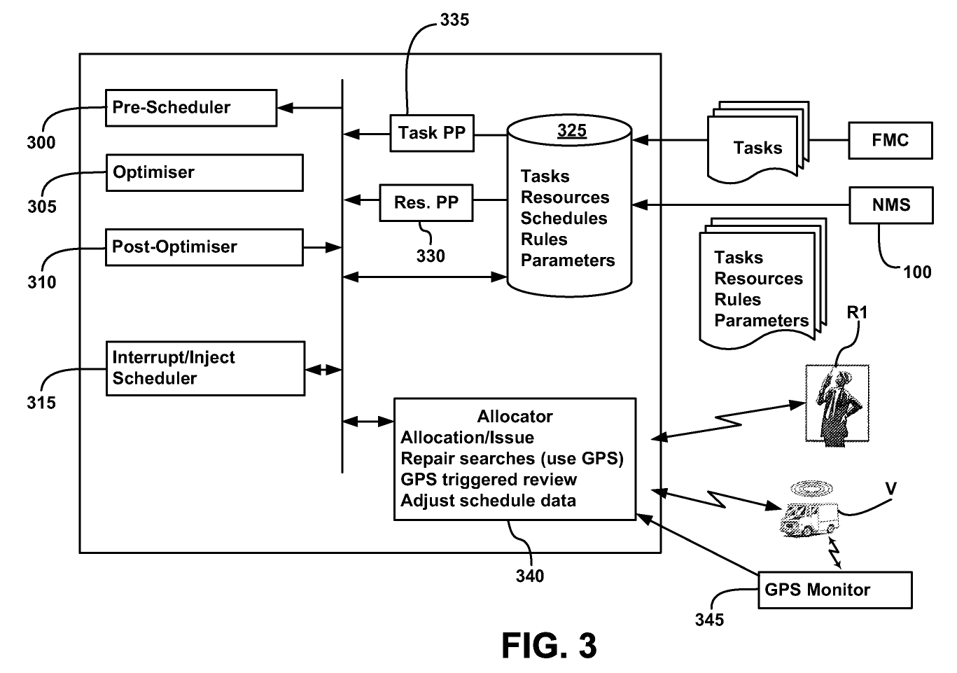

Task scheduling of a type that might be used with or in an embodiment of the invention as being described here is described in U.S. Pat. No. 6,578,005. Some aspects are described again here. Referring to FIGS. 1 and 3, the resource allocation system is provided with a main program for allocating the resources R1, R2, R3 to the tasks. The main program is divided into a set of routines. The method used by the resource allocation system initially calculates a provisional schedule based on tours for each resource, which is optimised, for example on the basis of task priorities, business costs and travel times between tasks. The provisional schedule is allocated and issued to the resources R1, R2, R3 as they call in. The resource allocation system also allows subsequent changes if for example a resource reports early completion, fails to report at an expected time, or if new tasks are requested after the provisional schedule has been created. Resource scheduling takes into account the following parameters:

whether a task needs more than one resource R1

whether a resource R1 is qualified to perform a task;

the time a resource R1 would take to travel to the location of each task;

the time a resource R1 would take to perform each task.

the relevant importance of each task, determined for example by the number of customers affected and any financial penalties which will be incurred if the task is not performed within a specified time period, or at all; and

the availability of the other resources R2, R3. The availability of these other resources R2, R3 depends on the times when they each will become available, which in turn depend on the lengths of their current tours, and the times the resources started doing them, as well as any travelling time necessary to reach the location of the task from their present locations.

The time that a task will take is subject to some uncertainty, since in many cases tasks involve the investigation and rectification of a reported problem. Until the problem is investigated the time it will take to rectify can only be estimated with a fairly large margin of error. There are also other variable factors, such as the local circumstances of each task, which makes a precise measure difficult.

The resource allocation system calculates a time-dependent “cost function” for each task. This takes into account evaluation cost criteria such as the penalty for failing to meet an agreed time (which is the same whoever does it) and the probability of the task failing (which varies from one resource to another). This probability depends on the projected finishing time of the resource's current tour, the amount of travelling time needed to get to the new task, the estimated duration of the new task, and the target time by which the new task must be done. These factors determine a margin, which is the amount of time by which the other factors can over-run without exceeding the target time or, if negative, the amount of time by which the target time will be missed. Other factors, such as the amount of non-productive time required for a specified resource to carry out the task (e.g. time spent in travelling, or waiting at the location for access if a “not before” appointment time has been made—that is, an appointment which is to take place after a specified time) can also be taken into account as additional evaluation cost criteria. These various factors, or evaluation cost criteria, need to be reduced to a common unit of measurement. Conveniently, all the factors may be measured in equivalent units of travel time. The cost of allowing a task to fail can be calculated as equivalent to the amount of non-productive travelling time it would be reasonable for a resource to expend to prevent that failure occurring. Alternatively, an equivalent financial value may be used. For example, if compensation at a specified rate is payable to a customer for a missed appointment, non-productive time can be costed such that the time one is prepared to use to avoid paying that compensation is costed at an equivalent value.

### Resource Allocation System

Referring to FIG. 3, embodiments of the invention comprise a resource allocation system comprising a plurality of scheduling elements for allocating resources to tasks; in a preferred embodiment these comprise a tour construction system 300, 305, and a task allocator 340. The tour construction system runs periodically, for example every fifteen or twenty minutes, while the allocator 340 responds to events such as a resource R1 calling in. These two systems run independently, but have read/write access to the same data store 325. This means that schedules generated and output by the tour construction system 300, 305 can be used as a starting point for the operation of the allocator 340. It also means that the allocator 340 can write data back to the data store 325 which the tour construction system 300, 305 can use in subsequent runs. Each system is typically a computer, controlled by a suitable program. Typically, the allocator 340 functions to control the current allocation of resources to tasks and actual issue of the tasks to the resources, whilst the tour construction system 300, 305 prepares the data for the next run of the allocator 340.

In one embodiment of the invention, the positioning system is implemented as a GPS monitor 345 of known type; the monitor 345 tracks vehicles V used by resources R1, R2, R3 in executing scheduled tasks and sends location updates for storage in the database 325 in respect of the resources R1, R2, R3. The GPS monitor 345 receives signals from GPS-enabled devices which can be correlated by the allocator 340 with the vehicles V and it converts latitude and longitude information into a grid reference for storage in the data store 325.

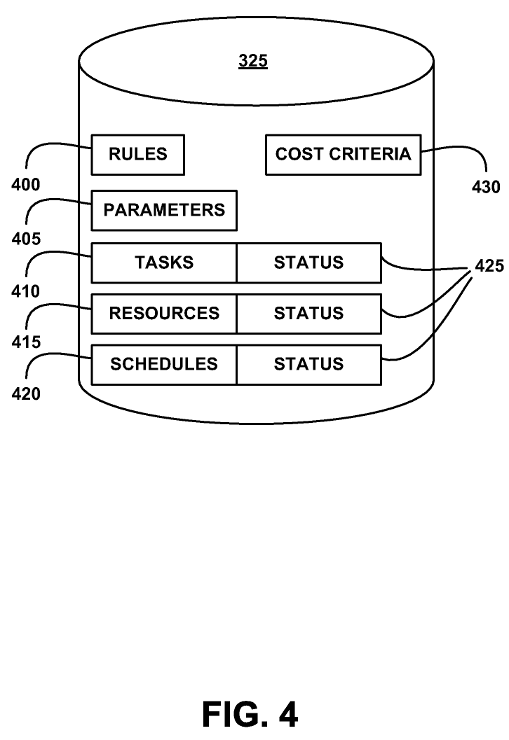

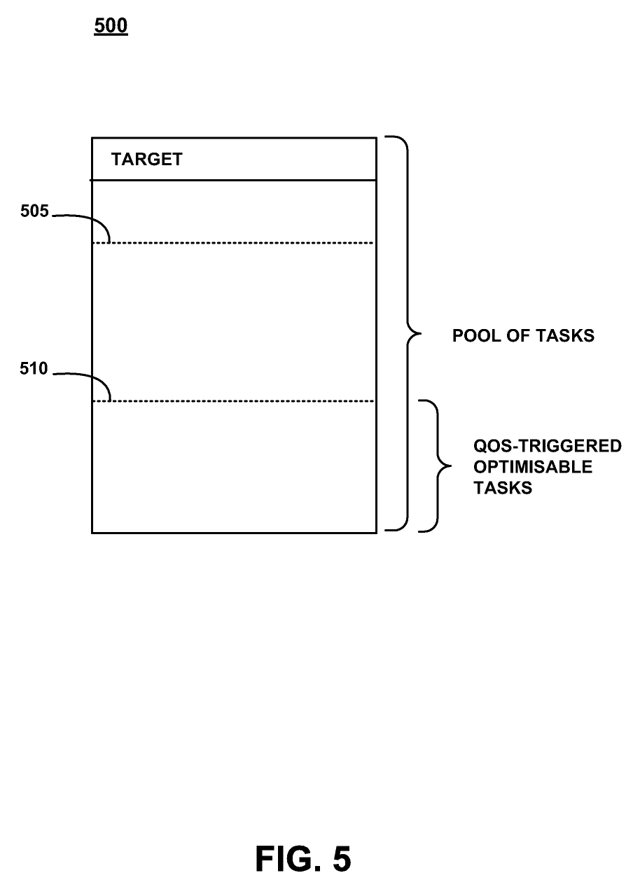

The data store 325 is shown in more detail in FIG. 4. It has a number of data structures which provide for example a rule store 400, an evaluation cost criteria store 430, a parameter store 405, a task store 410, a resource store 415 and a schedule store 420. These are supported by suitable input/output and search processes of known type. The data store 325 provides an important role in co-ordination of different parts of the system. Entries in at least the task store 410, the resource store 415 and the schedule store 420 have an associated field or data location, for example linked to respective stored entities by pointers or tables, which provide status registers 425 for the stored entities. The rule store 400 stores various rules applying to scheduling, such as the preferred treatment of co-located tasks and if and when an issued task can be interrupted. The parameter store 405 stores certain configurable values, such as the difference between a resource's GPS location and the resource's expected location that might trigger a re-estimation of travel time for that resource. The evaluation cost criteria store 430 holds the formulae for estimating a cost in relation to a task or a task/resource combination, various aspects of these costs being further discussed below. Referring to FIG. 5, tasks in the task store 410 will generally be categorised according to where they are in the scheduling processes. A task which has been scheduled (and therefore allocated) by the tour construction system 300, 305 but not issued by the allocator 340 might be marked as “pending”.

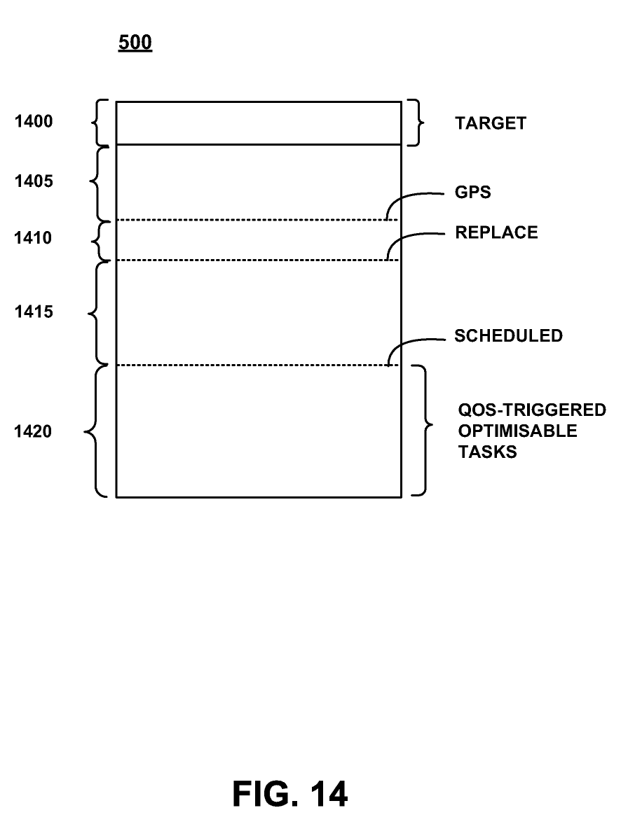

Tasks which have not yet been scheduled, and pending tasks form a pool of tasks 500 which can be sorted in order of priority, for instance according to the rules in the rules store 400 and the evaluation cost criteria in the evaluation cost criteria store 430, both mentioned above. These can be applied to data in the task description in the task store 410. Priority thresholds 505, 510 can be applied to the pool which will determine how tasks above and below the thresholds will be dealt with in various circumstances. For example, the tour construction system 300, 305 might be set to apply a high priority threshold 505 in order to identify tasks with a high evaluated cost that should be scheduled first, plus a low priority filter 510 for identifying tasks which are non-critical but need to be scheduled in the long term, for example to maintain quality of the network. The allocator 340 meanwhile might be set to recognise a very high priority “Target” category of tasks which are sufficiently critical to justify disrupting an existing schedule. Real time priority (“RTP”) thresholds of tasks in the task pool 500, used by the allocator 340 and for injection and interrupt scheduling, are further discussed below in relation to FIG. 14.

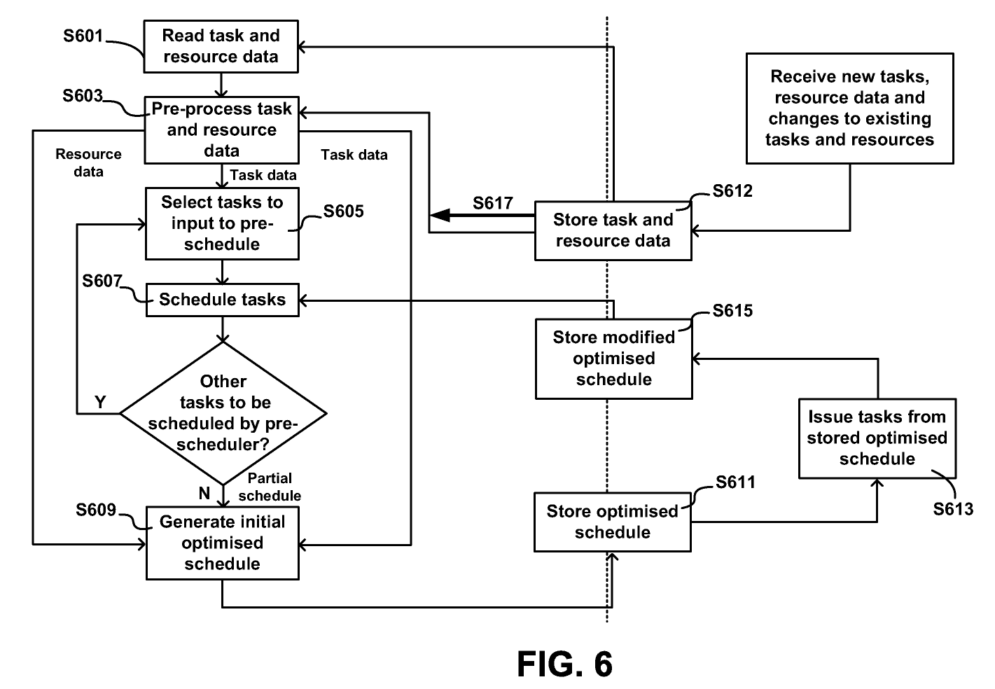

Returning to FIG. 3, this shows a general arrangement of the tour construction system 300, 305 for generating the initial optimised schedule. The initial optimised schedule may be prepared overnight, ready for the start of the working day. During the working day, the tour construction system 300, 305 will run periodically, on a time basis, for example every fifteen or twenty minutes. In the arrangement shown in FIG. 3, the tour construction system has two elements, namely a deterministic (rule and cost-based) pre-scheduler 300, and an optimising subsystem 305. Referring also to FIGS. 4 and 6, the pre-scheduler 300 reads data regarding the tasks and the resources to which they are to be allocated, from the task and resource stores 410, 415 in the data store 325 (step S601). This data undergoes some pre-processing in a resource pre-processor 330 and a task pre-processor 335 (step S603) before being input to the pre-scheduler 300. The resource pre-processor 330 and the task pre-processor 335 perform various functions as described in U.S. Pat. No. 6,578,005. The resource pre-processor 330 fixes, for each resource R1, R2, R3, the times of next availability, breaks, absences, and the “end of day” event. It will also note location of the resource for purposes other than tasks, such as where the resource has to fetch supplies, since this could affect the planning of a tour. It will also supply parameters of the tasks that each resource is capable of performing. The task pre-processor 335 will then select, at step S605, a “difficult to schedule” subset of the pool of tasks 500 (shown in FIG. 5) and supply details of these to the pre-scheduler 300. This subset might include for example the following:

a. Tasks that have inter-dependencies.

b. Tasks having a duration greater than a predetermined value.

c. Tasks that have limited choice of feasible resources.

These tasks may be considered “difficult to schedule” tasks and it is important to insert them into the schedule early. Once the “difficult to schedule” tasks have been scheduled (step S607), at least a second pass through the pool of tasks 500 is carried out by the task pre-processor 335 to select other “non-difficult” tasks and supply details of these to the pre-scheduler 300. A relatively full partial schedule can be passed to the optimiser 305. The optimising subsystem 305 also receives data regarding the resources to be allocated, and remaining unscheduled tasks from the resource pre-processor 330 and the task pre-processor 335 respectively. It then uses a stochastic process of known type to generate an initial optimised (provisional) schedule which it writes in known manner to the schedule store 420 (steps S609, S611).

The pre-scheduler 300 generates an initial schedule, for example in about thirty seconds, and the optimiser 305 may then take from one to four minutes to run, depending on the size of the scheduling domain in terms of numbers of resources and tasks involved. The optimiser 305 uses the same data set as the pre-scheduler 300 and sends the optimised schedule to the schedule store 420. This schedule is likely to contain some partial tours, i.e. tours with some idle time, since the tasks scheduled by the tour construction system 300, 305 are a subset of all the tasks available. In addition the tour construction system 300, 305 positions the “next available” time (normally the time that the resource is due to come on duty), breaks, scheduled absences, and the “end of day” event (the time that the resource is scheduled to go off duty) in each resource's tour. After a period of say fifteen minutes, this being configurable, the pre-scheduler 300 reloads the stored schedule (step S615), which has been updated to remove issued tasks (step S613), reads in (step S617) new tasks and any changes to tasks or resource data that have been entered to the database 325 (step S612), and runs again, followed by the optimiser 305, to generate a revised schedule with which it updates the database 325. The issued tasks can be stored until completed or returned as a repository of tour data for tour injection purposes.

The operation of the schedule generation system can be enhanced by periodically halting the operation of the optimisation stage 305, and running a post-optimisation stage 310. This post-optimisation stage 310 uses rule and cost-based criteria to assess the schedule developed thus far, identifying those parts which appear close to optimal, adding these to the fixed partial schedule generated by the pre-scheduling stage 300, and then re-running the tour construction system 300, 305.

### Use of Location Data by Tour Construction System

The tour construction system 300, 305 will use a number of criteria in prioritising and scheduling tasks into tours for allocation to specified resources R1, R2, R3. One of the factors is task location and this will be accounted for by calculating the travel time incurred in reaching a task location. This will normally be the travel time from the latest scheduled location for the resource or, if the task is the first of the day, then from the resource's start location. After the first optimised schedules of the day have been stored in the schedule store 420 of the database 325 (step S611), the resources R1, R2, R3 will start to execute their issued tasks and will move appropriately. Either as each task is executed, or when a tour of tasks has been executed, the resources R1, R2, R3 will call in to the allocator 340 to report task statuses. As the resources R1, R2, R3 call in, the database 325 and status registers 425 are updated with, among others, location data (step S612). These location data can take three forms, namely the scheduled locations of the resources R1, R2, R3 based for example on task locations; confirmation of locations of the resources R1, R2, R3 when they call in to the allocator 340; and GPS data collected by the GPS monitor 345 with respect to the vehicles V. GPS data takes precedence over confirmation of location by the resources R1, R2, R3 so that where a GPS feed is available, the confirmation of location by resources R1, R2, R3 is suppressed.

There are several ways in which location data relating to the resources R1, R2, R3 can be used. The pre-scheduler 300 can assume that the resources R1, R2, R3 will finish their last scheduled task at the location of that task (as specified in the task parameters). However, in practice, by the time a resource calls in to close that task and request further tasks, the resource may not be at or near the task location (e.g. they may be at a network node retrieving test equipment or may have returned to their vehicles V and driven to a different location before closing the task). As a result, assuming a resource location based on the location of the last task to be executed can reduce the optimality of a schedule. Whilst this would appear to point towards the use of actual location data as an input to the scheduling process and expecting an improvement to the schedule, judicial selection of when to use the GPS data is critical. This is because using GPS data without context of where, in the tour of tasks, the resource is, can introduce instabilities to the scheduling process.

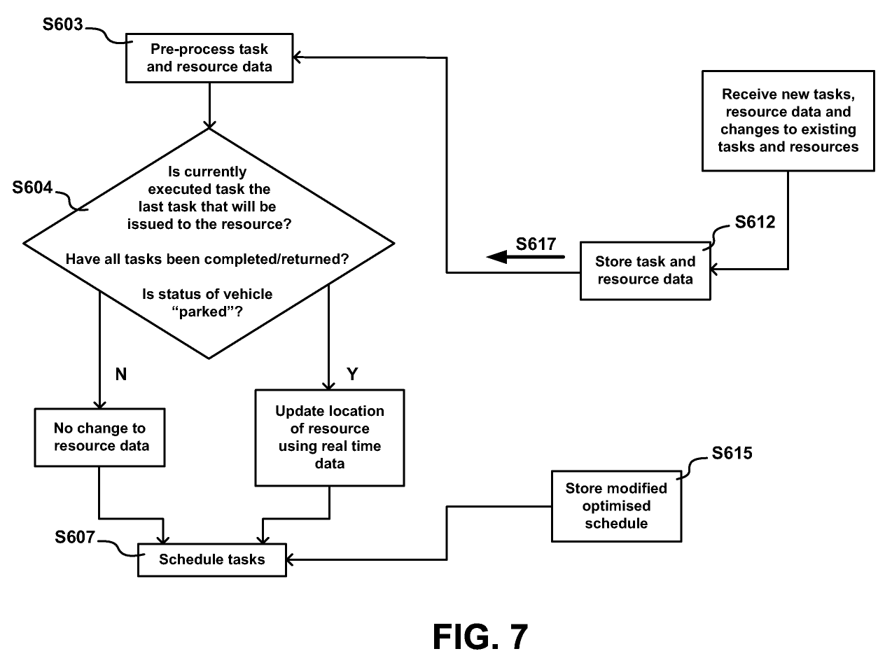

In a first embodiment of the invention, and referring to FIG. 7, GPS location is selectively used by the tour construction system 300, 305 in place of task location in respect of certain resources only. More specifically, GPS location data are used for those resources that fulfil one or more of the following criteria (step S604):
The resource is executing the last of the tasks that was issued to them;
all other tasks that had been issued to the resource are completed and/or returned; and
the status of the relevant vehicle is “parked”

This has the benefit of avoiding using the GPS location of a moving vehicle, and makes use of the observation that an appropriate time to substitute GPS location data for task location data by the tour construction system is while a resource R1 is executing the last of the tasks that had been issued to them (i.e. all other tasks that had been issued to them have been completed) and the status of the relevant vehicle V is “parked”. This is an “appropriate time” because the GPS location data will be stable and the starting point for scheduling a next task to the resource R1 will be based on accurate locations of the resource R1 in a greater number of instances.

This use of updated location data for the resources R1, R2, R3 can be implemented by means of a rule in the database 325 which will trigger use of the GPS data when the above conditions are met.

### Use of Location Data in Interrupt Scheduling

During normal scheduling, new tasks continually arrive in the task store 410; some of these are urgent. For example, a major data cable might have been cut by heavy machinery. It may also be the case that an important task previously scheduled might be at risk of not being executed, for example because a resource has fallen ill or because a schedule was created on the basis of data which has subsequently changed.

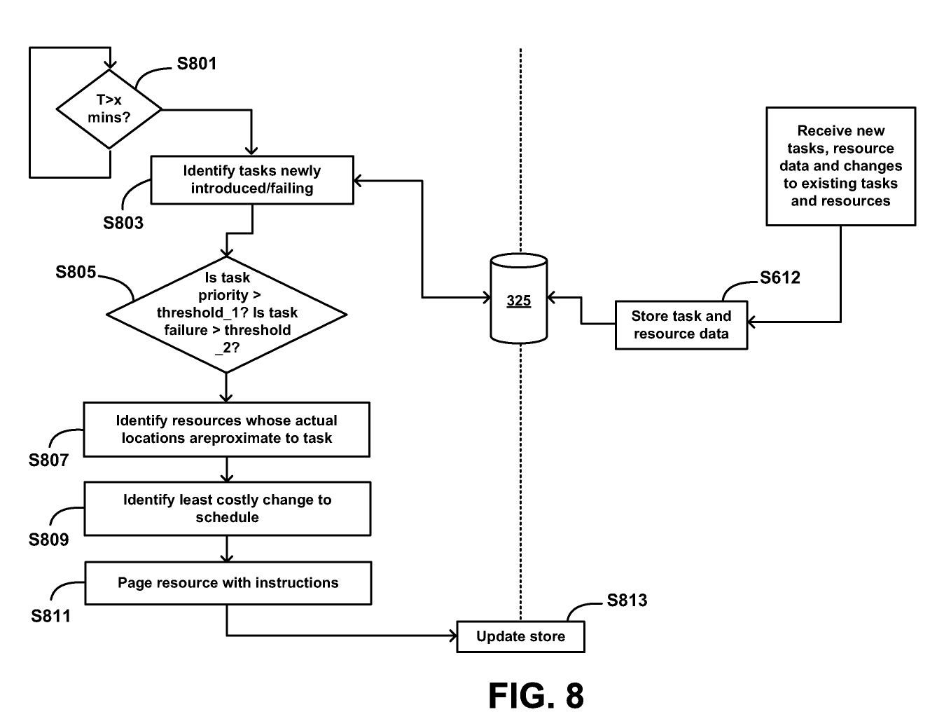

Referring to FIG. 8, in parallel with receiving updates to task and resource data (step S612) the interrupt/injection scheduler 315 runs a search periodically, for example every three to five minutes (step S801), through the task store 410 and its status register 425 in order to detect important tasks newly introduced or identified as scheduled to fail (step S803). If any such task is found, it will run tests:
is its importance above the interrupt threshold, e.g. major failure of exchange/safety/emergency equipment?
is it within x mins to failure (e.g. less than 60 mins to start time)?

If a task is detected that meets both tests (step S805), the interrupt/injection scheduler 315 will search for resources whose locations (vehicle GPS) are currently indicated within a certain radius of the urgent task location and which are not currently executing a task whose status is “uninterruptible” (step S807). The schedules of any such resources found will then be reviewed to identify a least expensive modification to the overall schedule (step S809). This review is done on the basis of the resource's current and next locations. In this case it does not matter if the vehicle is not parked or if they have other issued tasks. Once the modification has been identified, the interrupt/injection scheduler 315 will instruct the allocator 340 to use a “push” mechanism to issue the urgent and important task to the relevant resource, to be executed in preference to any task the resource is currently executing (step S811). In practice, the allocator 340 will contact (page/SMS) the relevant resource in order to make the resource call in (come on-line) to be issued with the urgent task. This task will now usually be given the status “uninterruptible”, and the store 325 (more specifically resource portion 415 of the store) updated accordingly (step S813).

This behaviour is at odds with that of normal scheduling in which work is usually only issued when previously issued tasks have been completed and “closed” by the resource R1, R2, R3.

### Use of Location Data in Injection Scheduling

Injection scheduling has particular relevance where the tour construction system 300, 305 schedules series of tasks as tours. As described above, a tour of tasks can be considered to be “frozen” after issue to a resource by the allocator 340; injection scheduling allows subsequent changes to be made to the tour, for instance filling gaps in a tour. Such gaps in a tour can arise post-issuance of a tour for various reasons, such as “task completed early”, “task un-executable” or “task cancelled by the customer”.

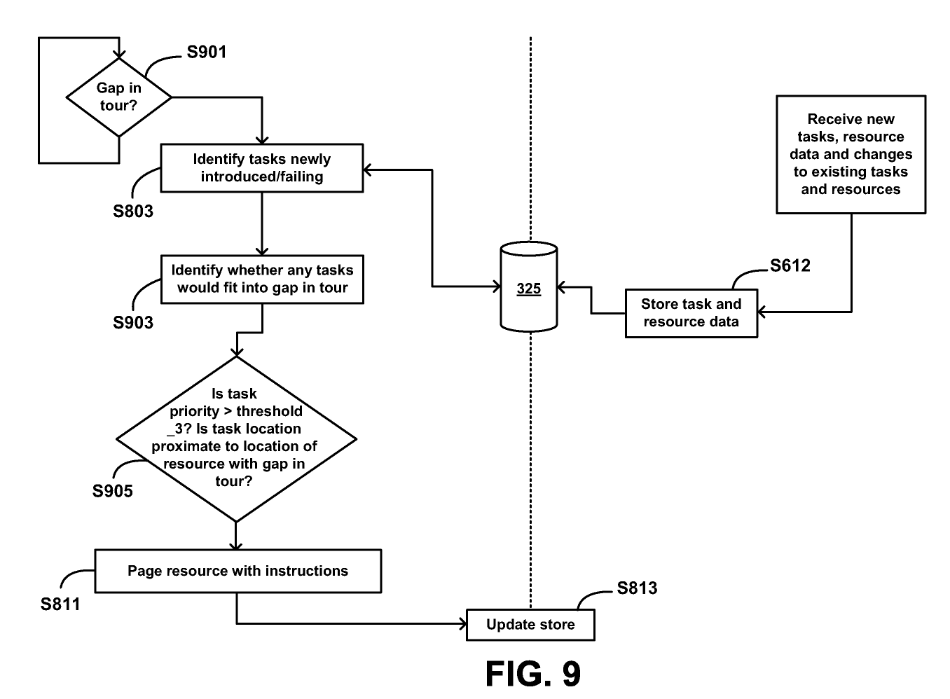

Referring to FIG. 9, the trigger for the periodic search is identification of such a gap in the tour, e.g. in response to a change in task status (step S901). The results of the periodic search that is run by the interrupt/injection scheduler 315 (to detect important tasks newly introduced or whose status has changed from pending) are then reviewed (step S803) to see if any of them would fit into the identified gap within the issued tour (step S903). If any such task is found, as indicated at step S905, the interrupt/injection scheduler 315 will run tests to determine the following:
is importance of the task above injection threshold?
is the task location within a radius of the location of unexecuted tasks in an existing, issued but incomplete tour?

If a task is detected that meets these criteria, the interrupt/injection scheduler 315 instructs the allocator 340 to use the “push” mechanism to issue the urgent and important task to the relevant resource (step S811). Instead of instructing the resource to interrupt a current task, the resource is sent details of the task and left to plan the new task into their tour at will. Again, the allocator 340 will contact (page/SMS) the relevant resource in order to make the resource call in (come on-line) to be issued with the additional task.

To avoid problems where a resource is already travelling to a next task in a tour, and may have given an estimate of arrival time to the customer, the tests performed at step S905 may include a test based on the status of the resource's vehicle status; for example, task injection may be limited to circumstances in which the vehicle of the resource has the status “parked”.

### Allocator Component

As described above, the tour construction system 300, 305 runs a full scheduling process and optimises task allocation based on minimising business cost overall. The allocator system in contrast is dealing with a simpler scenario, triggered by input from one entity at a time, and usually only has to take into account task priority and location in relation to an individual resource and a set of tasks. The allocator 340 can be triggered by the interrupt/injection scheduler 315 in response to changes to tasks (as described above), or, more commonly, by a resource R1 calling into the scheduling system; furthermore the allocator 340 can be triggered in the event that GPS location data are sufficiently different to a location expected based on the schedule for the resource R1.

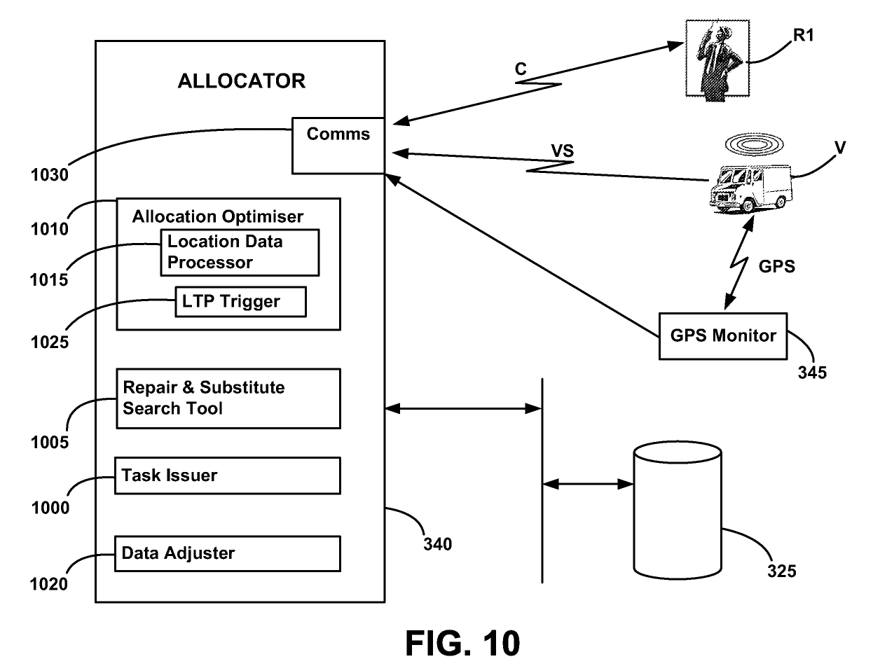

Referring to FIG. 10, a resource R1 may call into the scheduling system in a number of situations. These comprise: the start of the day to request issuance of a tour; calling in to close the last task at the end of the day, constituting an End of Day (“EOD”) event; or calling in because they have run out of tasks earlier than the EOD (for example because a tour has been completed or one or more scheduled tasks has proved not possible for one reason or another, e.g. because the resource R1, R2, R3 could not obtain access to the relevant premises). The allocator 340 is equipped with a communications module 1030 providing the protocols enabling it to communicate with the resources R1, R2, R3 in this manner. The communications module 1030 receives incoming information delivered by a mobile communications link C and sends information in known manner, via a paging or on-line link which can also be represented by the link C. The communications module 1030 also provides a receiver for the vehicle status information on the vehicle mobile connection VS and for data from the GPS monitor 345. This enables the allocator 340 to monitor the locations of the resources' vehicles V obtained via a GPS monitor 345; the GPS monitor 345 provides a data feed which is asynchronous and can thus be a few minutes out of date. The trigger for a GPS update can be contact made by a resource R1, R2, R3 when coming on-line.

The allocator 340 is managed such that changes which have come about since the schedules were last generated by the pre-scheduler 300 and optimiser 305 can be taken into account at the earliest or most opportune moment. Such changes may be caused by resources R1, R2, R3 reporting in for new tasks earlier or later than expected, absences requested at short notice, changes to a scheduled task (e.g. an amended appointment), new tasks entering the system, or changes to the scheduling and allocation rules 400, such as a change to travel times to account for adverse weather or traffic conditions. The objective is to make sure that when a resource requests a task, the task actually issued is the most suitable task available for that resource at the time the request for work is dealt with, whether or not it is the one originally scheduled. Examples of suitable allocation and optimisation rules are described in U.S. Pat. No. 6,578,005.

The allocator 340 comprises several processing components, which enables it to review and respond to incoming information in this manner. These include allocation optimiser 1010, repair and substitute search tool 1005, task issuer 1000 and data adjuster 1020. The allocation optimiser 1010 will be described in more detail below, but it responds to task requests, applying rules in order to trigger an appropriate type of search and to supply appropriate data to the search tool 1005 on which to base a search, such as location data and in certain situations task priority data. The substitute search tool 1005 runs searches in the database 325, while the task issuer 1000 issues scheduled tasks and tours to resources, using the communications module 1030 and the data adjuster 1020 adjusts data in the database 325, for instance in a status register 425 after repairing or adjusting a schedule, or in the schedule store 420 or the resource store 415.

In addition to being equipped with the functions of the allocator 340 described above, the allocation optimiser 1010 is provided with processes 1015, 1025 for identifying additional conditions that may require a real-time response. The allocation optimiser 1010 runs whenever a resource R1 calls in to report a change in circumstance such as closing a task or tour. If there is a requirement for the resource R1 to be issued a further task, then the allocation optimiser 1010 may need to run either a repair search or a substitute search. A repair search is performed when there are no more scheduled tasks for a resource R1, R2, R3 but it is not end of day for the resource, whereas a substitute search is performed when there is a next scheduled task but it may not be the most appropriate in view of the real time circumstances. If there is no feasible pending task waiting for issue to the resource, then the allocation optimiser 1010 needs to run a repair search. If there is a feasible pending task waiting for issue to the resource, then the allocation optimiser 1010 may still need to run a substitute search.

In the case that there is a feasible pending task waiting for issue, the allocation optimiser 1010 makes the following checks, using the location data processor 1015 and the low task priority trigger (“LTP trigger”) 1025:
1. Is there a significant difference between the current GPS location data and expected location data for the resource R1?
2. Is the next task due for issue to the resource R1 of significantly low priority?

If the answer to either of these checks is positive, then the allocation optimiser 1010 may need to run a substitute search so as to take account of new information to try to improve the next allocated task and thus the schedule.

In the case of either a repair search or a substitute search, it is necessary for the allocation optimiser 1010 to make appropriate location data available to the repair and substitute search tool 1005 and it does this by running the location data processor 1015 on the location data that is available for the resource R1, such as last closed task location, current GPS location and any nearby asset location. The intention is to prevent subsequent tasks being issued only in relation to the GPS location or only in relation to the last closed task location, for example, as either of these practices may be detrimental, for example reducing area coverage or issuing a task that is too far away from the resource R1 for them to reach it in a practical time.

The search tool 1005, so far as it runs repair searches, and the data adjuster 1020 of the allocator 340 are generally of known type, as disclosed in U.S. Pat. No. 6,578,005. However, according to an embodiment of the invention, both repair and substitute searches can now potentially be based on improved location data for a resource R1, R2, R3 and substitute searches can be triggered by GPS data indicating that the resource might be at a location other than that for which the schedule was optimised. Further, having the GPS location of a resource R1, R2, R3 can alert the system to potential travel time problems not allowed for in an existing schedule, and/or can provide an opportunity to update start times based on revised travel time estimates (to be described below).

In cases in which there are no more tasks or tours scheduled for a resource by the tour construction scheduling system 300, 305 but it is not end of day for the resource, the allocator 340 will make a repair search in the pool of tasks 500 for one or more suitable tasks for issue to the resource. In cases in which the GPS data for a resource's vehicle differs significantly from the expected location of the last executing task for that resource, the allocator 340 is triggered by the GPS data to make a substitute search. In cases in which the priority of a scheduled task about to be issued indicates that it is worth looking for a more important one which may have entered into the pool of tasks 500 as a result of recent events, the allocator 340 will make a substitute search for a fresh task of higher priority than that of the currently allocated task.

The repair and substitute searches each include location data in respect of the resource as a factor. The location data actually used may vary according to circumstance and may be selected after some processing of the resource's latest known GPS location. For example, if the GPS location is close to a last scheduled task, the task location may be used in the repair or substitute search. At certain times of day, the location data may in practice be an interpolated position between the GPS location and the last scheduled (closed) task location. This processing of the GPS location is further discussed below.

### Triggers for Substitute Searches

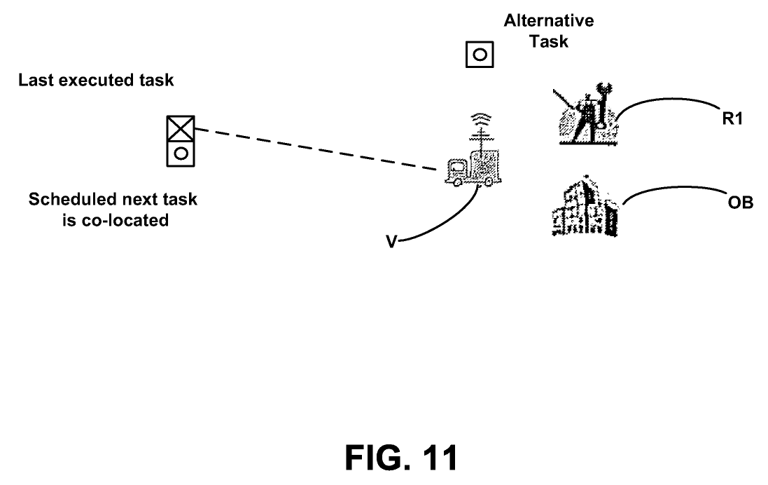

Referring to FIG. 11, a resource R1 has finished a tour of scheduled tasks and returned to an operational building OB or a node within a network to close the last task of the tour and obtain details of a next task or tour of tasks. The first step for the allocation optimiser 1010 is to check whether a repair or a substitute search is appropriate. If there is a pending task for the resource R1 which could be issued, there is no need of a repair search; however the allocation optimiser 1010 may still need to run a substitute search. In order to determine whether or not this is necessary, the allocation optimiser 1010 checks the priority of the pending task against a current stored parameter, using the LTP trigger 1025, and runs the location data processor 1015.

In this scenario, the priority of the pending task is not sufficiently low to trigger a substitute search but the allocation optimiser 1010 determines that the resource's vehicle V is parked 5 km from the scheduled location of the last executed task (e.g. from a look up of location data in the database 325 and a check against the scheduled location of the last executed task). The current GPS data confirms that the vehicle is still some distance from the scheduled location of the last executed task and the optimiser 1010 triggers a substitute search by the search tool 1005. The substitute search is based on the most appropriate location data for the resource R1, this being assessed according to rules and real time location data available to it, in a manner further described below, and supplies the newly assessed location data to the search tool 1005. The search tool 1005 will now look for tasks for issue to the resource R1 whose locations are more relevant to the newly assessed location data for the resource R1.

In the scenario shown in FIG. 11, there is a scheduled task co-located with the last executed task and an alternative task near the current vehicle location; the alternative task becomes a candidate task for substitution of the scheduled task, and selection between the tasks will be dependent on the relative priorities of the next scheduled and alternative tasks. If the alternative task is selected, and that task had been scheduled for another resource R2, the allocation optimiser 1010 will also delete the alternative task from the schedule of the other resource R2 and change a status value for all other tasks in the other resource's schedule to indicate that the tasks need to be re-assessed during a next scheduling event. For example a suitable scheduling event could be a subsequent run by the tour construction system 300, 305, whilst another could be real-time re-scheduling of the affected tasks.

The scenario outlined above introduces a parameter which determines whether a substitute search will be triggered, this being the distance of the vehicle's GPS location from the location of the last executed task for the relevant resource R1. The parameter can be used to introduce a threshold distance, for example 3 km, or estimated travel time, below which there is no substitute search and the next scheduled task would simply issue to the resource R1. Since the consequence of a substitute search can be a schedule change, it may be preferred that the criteria triggering a substitute search are relatively stringent.

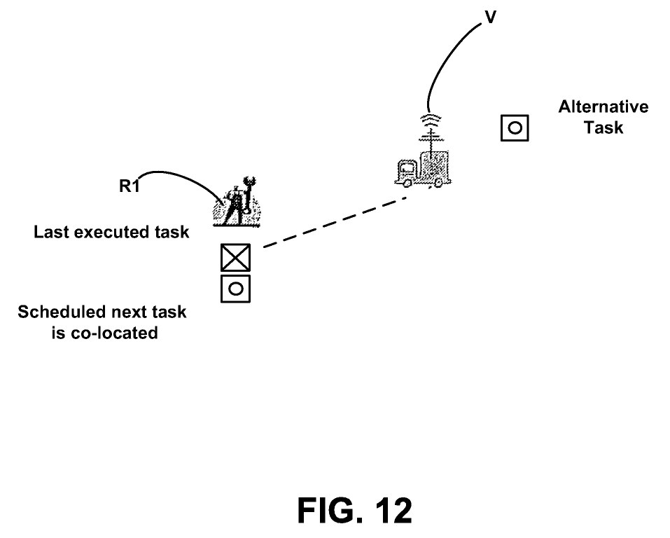

Referring to FIG. 12, a scenario in which the GPS distance is below the threshold distance (or estimated travel time) will now be described. A resource R1 calls in to close the last task of a tour. The resource R1 has failed to park very close to the last executed task, and has instead parked within walking distance of the task, say 600 m away.

The first step for the allocation optimiser 1010 is, again, to check whether a repair or a substitute search might be appropriate. In this example it finds that there is a pending task scheduled for the resource R1 which could be issued and there is therefore no need of a repair search; it then proceeds to check the priority of the pending task and runs the location data processor 1015 in order to determine whether or not a substitute search is required. In this case, the distance of the resource from the last task in his tour is below the threshold distance 5 km, and as a result the allocation optimiser 1010 determines that there is no need of a substitute search based on location. However, in this example, it turns out that there is an urgent alternative task which is located near the current GPS location of the resource's vehicle V. Absent a mechanism for catching such a newly introduced task, the task would remain unallocated and would most likely fail. However, embodiments of the invention are configured to enable the interrupt/inject scheduler 315 to pick up the existence of this task, and thereby provide a mechanism for dealing with urgent tasks and allocating them to a resource, while avoiding unnecessary disruption to already scheduled tasks.

It will be appreciated that the decision as to whether or not to run a substitute search takes account of various factors, some of which are not pertinent to other scheduling-related decisions. For example, task start times are mainly dependent on how long it will take to reach an issued task, and this calculation can make use of real-time GPS data irrespective of any decisions taken to factor in the GPS data to the scheduling process. Thus in one arrangement the allocator 340 decouples decisions determining whether or not to use of GPS for scheduling purposes from other purposes, and uses the GPS location (either the raw location data, or a static location, to be described below) to recalculate estimated travel times, if necessary adjusting start times of respective tasks.

A further trigger for the substitute search is a notification that the GPS data has deviated from an expected (scheduled) location by a predetermined amount; this will be described in more detail below, in the section entitled “Use of Thresholds”.

### Types of Location Data

In the examples described with reference to FIGS. 11 and 12, substitute searches are triggered on the basis of GPS data received from the GPS monitor 345. However, it may be the case that a more appropriate location, other than is obtained from the GPS monitor 345 alone, should be used.

The current location of a resource R1 will generally be set to the last known GPS data of their vehicle when parked unless the difference between the GPS data and another significant location is below an appropriate threshold. In that case, the current location of the resource R1 “snaps” to, that is resets to, the other significant location. This will generally be a scheduled task location and this bias is preferred since it tends to maintain the schedule produced by the tour construction system 300, 305 and could enable special co-located allocation rules and bias.

In practice, there is more than one type of location that the resource R1 (as opposed to their vehicle) might be in, such as customer premises, asset locations and locations where resources R1, R2, R3 tend to congregate at breaks, such as cafés. An asset location is the location of an asset of the resources' employer rather than that of a customer. For example, where the resources R1, R2, R3 are telephone technicians, asset locations might include exchanges or significant network nodes. These locations are stored in the database 325 for reference and appear in a schedule if a task is known to be located there rather than at customer premises. It is possible for the GPS location of a resource's vehicle to be close to an asset location, and under certain circumstances, it may be appropriate to “snap” the current location of a resource R1 to an asset location rather than customer premises. For example, the location of a scheduled task might be at the customer premises but the resource R1 might close the task at an exchange. In the event that the last scheduled task was at customer premises, it would still be possible for the current resource location to be “snapped” to an asset location if GPS data located the parked vehicle significantly closer to the asset location than the last task location. This might be taken as a fairly clear indication that the resource in practice will close a job at the asset location; in this case the GPS data are used as an indicator for selecting a location (in this case asset location) rather than being used in its own right.

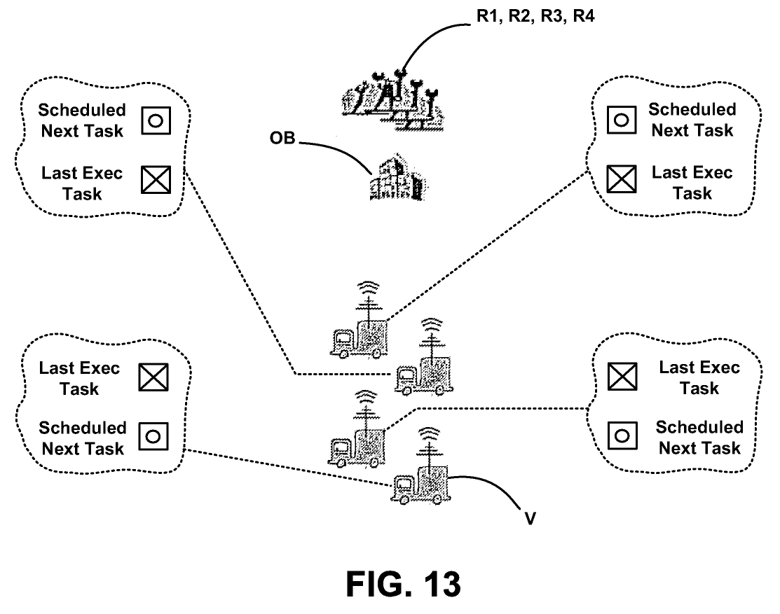

Referring to FIG. 13, a complication arises with respect to break times when multiple resources R1, R2, R3 tend to congregate at a particular building such as a café at a particular time of day. The GPS location of the vehicles now has a different significance, being less tightly coupled to the location of a task. In these circumstances, it is preferred that some note is taken of the last closed task location so that the resources are biased to keep to the areas they were originally working in so as to maintain area coverage. If substitute tasks were to be scheduled purely on the basis of the GPS locations of the vehicles V, this may not happen. On the other hand, the GPS data does indicate that the resource R1 is not at the location of the last executed task and that therefore scheduling on the basis of the location of the last executed task may also not be optimal. The solution here is to use a location which is an interpolation between the GPS location and that of the last executed task. This can be calculated for example as a percentage of the difference between the last scheduled task location and the GPS location, the percentage being based on a parameter that might depend on circumstances or be configured in the database 325. This interpolated location introduces a vector for the resource R1 in a direction back towards their last executed task.

It is necessary in this last scenario for the optimiser 1010 to run a check on whether the resource R1 is likely to be on a break and/or is located very close to other resources. This can be done for example either by time of day or by reference to the resource's scheduled status which might indicate a break. If the GPS location for the resource's vehicle V is further from the last scheduled task location by an amount above the threshold for running a substitute search but the resource also has a high probability of being on a break or being close to other resources, the location data used for both the repair and substitute searches is now the interpolated location, somewhere between the GPS location and that of the last executed task.

### Use of Thresholds

A method of scheduling by the tour construction system as generally based on task and resource parameters is described in U.S. Pat. No. 6,578,005 and is not further described herein. Other methods for scheduling by the tour construction system could of course be substituted without departing from an embodiment of the present invention which primarily concerns adjustment of schedules already generated. This adjustment depends at least in part on the relative priorities of tasks already scheduled or newly added to the system. It is preferred however that tasks are mainly scheduled off-line as the off-line scheduling can be done with a high degree of information about multiple tasks, multiple resources and various long term factors.

Referring to FIG. 14, the pool of un-issued tasks 500 which might be used in either offline scheduling or real-time optimisation or repair, including use of interrupt and inject scheduling as well as use of the allocator 340, can be searched on the basis of various priority factors. In the scheduling performed by the tour construction system 300, 305, the importance of a task is likely to be measured in terms of the penalty of the task not being carried out, and this might be measured in compensation to a customer or loss of reputation. The allocator 340, however, will be searching in terms of “real time priority” or RTP and various factors are taken into account in allocating a task from this pool 500 in real time to a resource R1. Firstly, the resource R1 must meet certain criteria and then a suitable task must be found for that resource R1 in the real time conditions of that resource's location, availability and existing schedule. For example, the resource R1 might be reviewed in terms of:

current location

time remaining of working hours

location at which the resource R1 must end the working period

preferred working location/area

mobility limit

does the resource have a feasible next task already scheduled

If the resource R1 has a feasible next task already scheduled, the allocator 340 may run a substitute search as described above. Where the LTP trigger 1025 is involved, for example, there may be an unscheduled task in the pool 500 which is flagged as very important and also near to its commitment time. Assuming the resource R1 has the necessary skills, this unscheduled task may be swapped into the resource's schedule.

If no task has been found, tasks in further sets are reviewed, such as high priority tasks already allocated to another resource R2 but which the on-line resource R1 could attend earlier. If there is no higher priority task that can be found using these various criteria, the resource R1 will either retain an existing lower priority scheduled task or, if there is not a feasible scheduled next task, the resource R1 will be instructed to contact their supervisor.

As described above the allocator 340 can be triggered when a GPS data feed indicates that the resource R1 is far from a scheduled task location. The allocator 340 runs a substitute search in the pool of tasks 500 for a task which lies either in the target priority band 1400 or in a lower “GPS” priority band 1405. The allocator 340 functions to swap in one of these tasks in place of a scheduled task which is for instance in the lowermost category, the “QOS-triggered optimisable” priority band 1420. This means that higher priority work will not be swapped out and will still execute as scheduled, even if the resource R1 takes a longer than expected time to reach it as there may not be another resource R2 to take it on. The addition of the GPS trigger does however increase the number of optimisations occurring overall since the trigger, a high value for the distance between a scheduled task and the GPS location of a vehicle, causes optimisation in situations where it would not otherwise happen: namely where there is significant travel benefit detectable in real time.

There is more than one parameter that might act as a “GPS trigger” and these are configurable via the database 325. For example, a first parameter might be a threshold value for the difference between the location of a last executed task for a resource R1 and the location given by a GPS data feed from their vehicle. This value might be used to re-estimate task start times rather than to make a change to a schedule, as described above. A second parameter might be the actual benefit in distance that might be gained by swapping in a different task from the pool 500. For example, if the GPS feed indicates that a resource R1 is five miles east of their last scheduled task and the next scheduled task is five miles west of the last scheduled task, then the resource R1 might have ten miles to travel. If there is a task only two miles from the GPS location, then the actual benefit of swapping the tasks in distance terms is eight miles. This actual distance benefit can be used as another “GPS trigger” value for measuring whether a potential substitution should actually be made.

Still referring to FIG. 14, there is a “replace” threshold band 1410 which is slightly below the GPS threshold band 1405. No task below the “replace” threshold band 1410 is to be scheduled by any optimiser 305, 310, 1010 to replace another already scheduled task. This maintains a significant quality of service benefit in any optimisation that disrupts a schedule.

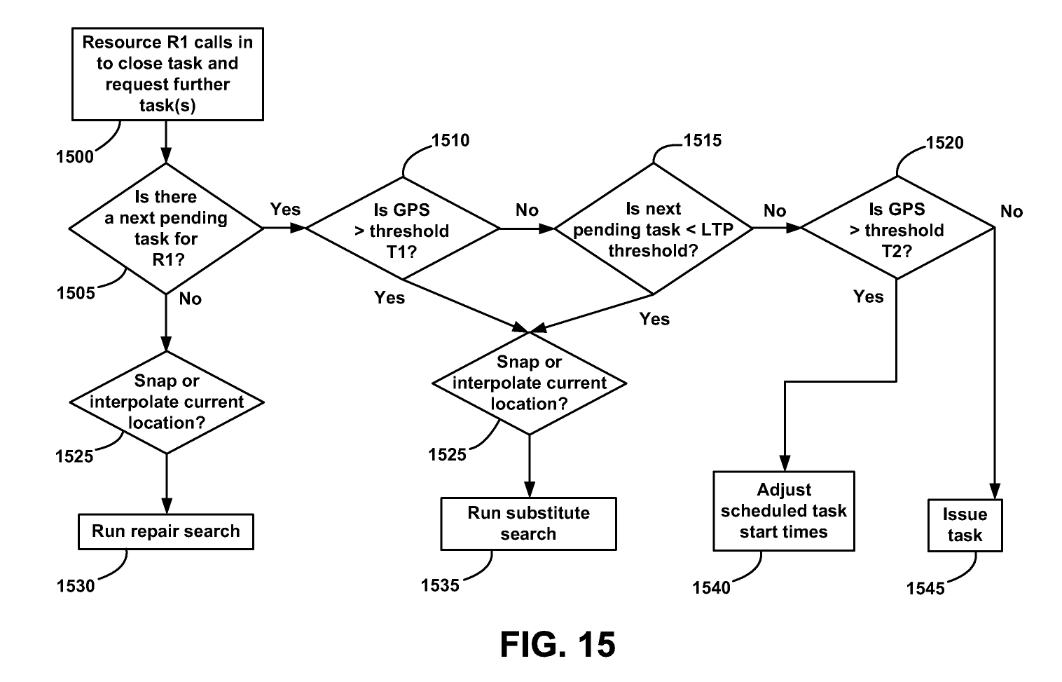

Referring to FIG. 15, an example of the response of the allocator 340 to receipt of real time information such as might be received when resources R1, R2, R3 call in or the GPS monitor 345 provides GPS location updates will be described. At step 1500, a resource R1 calls in to close a task and request further tasks. The status of the vehicle is parked and the allocation optimiser 1010, responds to the new event. At step 1505, the allocation optimiser 1010 reviews whether there is a next pending task for the resource R1. If there is no pending task, a repair search is run and the process moves to step 1525. If there is a pending task, the process moves to step 1510, which involves the GPS location data processor 1015 testing the latest GPS data for the resource R1 to see if there is a discrepancy in expected (scheduled) location above a threshold T1 at which a substitute search should be run. If there is, the process moves to step 1525. If there is not discrepancy, the process moves to step 1515.

This step involves the LTP trigger process 1025 reviewing whether the real time priority of the next pending task for the resource R1 is below the LTP threshold. If it is, the process moves to step 1525. If it is not, the process moves to step 1520, at which point the GPS location data processor 1015 tests the latest GPS data for the resource R1 to see if there is a discrepancy in expected (scheduled) location above a second threshold T2. If there is, the process moves to step 1540. If there is no discrepancy, the process moves to step 1545. Step 1525 comprises running a repair search or a substitute search, and involves the GPS location data processor 1015 testing whether the search should be based on a location for the resource which has been obtained (“snapped”) from the most recent GPS location to another location such as an asset location, or to an interpolated location. This might apply if the resource R1 is in a scheduled break. Once any necessary adjustment is made, the process moves to either step 1530 or step 1535 and a search is run based on the adjusted data.

At step 1530 the repair and substitute search tool 1005 runs a repair search (described above), whereas at step 1535 the repair and substitute search tool 1005 runs a substitute search (also described above). The outcome of these processes is adjustment to the scheduled start times in the database 325 (step 1540), and issuance of a fresh task or tour of tasks to the resource R1 (step 1545). In practice, step 1545 usually also follows steps 1530 and 1535, and, as described above, irrespective of whether the substitute search is executed at step 1535, the GPS data is used to recalculate estimated travel time so as to adjust expected start times accordingly.

### Additional Details and Modifications

Whilst in the above-embodiments decisions taken relating to the rescheduling, or otherwise, of tasks are taken based on distance, it will be appreciated that the parameter of interest to the scheduling process is location variance (i.e. by how much the location has changed since the previous schedule was generated so as to trigger a change to the schedule). As has been described above, since tasks are performed at different physical locations, travel time is an important factor to take into consideration; accordingly, as an alternative to using distance between actual (or “snapped to”) location and the location of a next allocated task, travel time can be used; this has the advantage of accounting for journey-related factors, to which distance per se is insensitive.

The above embodiments are to be understood as illustrative examples of the invention. Other embodiments are envisaged: in particular, embodiments can be implemented on the basis of data received from position determining systems other than GPS. For example, location may be determined by ranging or timing with global navigation satellite system (GNSS) signals such global orbiting navigational satellite system (GLONASS) signals, Galileo signals and the like. The GNSS signals are normally broadcast by satellites but may be broadcast by pseudolites. Location is preferably in the form of geographical coordinates such as latitude, longitude and altitude along with time.

Location can also be determined with terrestrial positioning systems. One example of such terrestrial positioning system is the system proposed in U.S. Pat. No. 5,173,710 entitled “navigation and positioning system and method using uncoordinated beacon signals” incorporated herein by reference. Another example is the hybrid radio location system using both radio and GPS pseudo ranges that is described in U.S. Pat. No. 6,430,416.

Another example is the system described by Matthew Rabinowitz and James Spilker in U.S. application Ser. No. 10/159,478 filed May 31, 2002 entitled “position location using global positioning system signals augmented by broadcast television signals”. This application shows methods and apparatus using broadcast television signals in conjunction with GPS signals to determine the position of a user. Another example is the system described by Matthew Rabinowitz and James Spilker in U.S. application Ser. No. 10/054,262 filed Jan. 22, 2002, entitled “time-gated delay lock loop tracking of digital television signals”. This application shows methods and apparatus using a plurality of digital television transmitters at known reference points to determine the location of a user.

Other examples of location determination systems that may be used for determining location are radio navigation systems (RNS) using either triangulation or timing, position augmentation services (PAS) using local location signals transmitted from local reference points to augment RNS and/or GNSS signals, and the like. One such system known commercially as a Terralite™ XPS system made by Novariant, Inc. of Menlo Park, Calif., uses self-surveying XPS stations for augmenting the GPS system.

### Clauses

A method of issuing an unissued task to a resource, the resource having a plurality of allocated tasks associated therewith, at least some of said plurality of allocated tasks being stored as a sequence of issued tasks in a storage system, the storage system holding location data indicative of an actual location of the resource, the method comprising:

reviewing task data indicative of tasks that are either scheduled or unscheduled and have not been issued to a resource so as to identify, from said task data, a task of a first type;

identifying a location of the identified task of a first type;

accessing the storage system so as to select at least one resource from a plurality of resources on the basis of a concordance between the identified task location and the actual location of respective ones of said plurality of resources;

issuing the identified task to the selected resource; and

updating the storage system to include the issued task for the selected resource.

A method as above, in which the issued tasks are stored in association with an execution status and the method includes selecting the resource on the basis of the execution status of already issued tasks, whereby to select a resource.

A method as above, in which selection of the resource is further based on a distance between said actual location and a location of a next issued task in the sequence, wherein the location of the next issued task is predetermined.

A method as above, in which the task data further comprises issued tasks and the step of reviewing the task data is triggered in response to notification of a task whose status has changed from issued to unallocated, the method further comprising selecting the at least one resource on the basis of concordance between temporal data associated with the respective tasks and temporal data associated with the unallocated task.

A method as above in which the task data includes priority information associated with a given task and the method further includes identifying tasks of a predetermined priority, whereby to identify said task of the first type.

A method as above, further including identifying said task of the first type on the basis of a relationship between the temporal data associated with the respective tasks and the current time, whereby to identify said task of the first type.

A method as above, including receiving location derived from a Global Positioning Satellite (GPS) system, whereby to receive the actual location of a resource for access via the storage system.

A method as above, in which the actual location of a resource is derived from a GPS system associated with a vehicle.

A method as above, in which the actual location of a resource is derived from a GPS system providing input to a terminal associated with the resource.

A method of modifying a schedule of tasks allocated to a resource, the schedule comprising a list of tasks comprising a plurality of tasks to be used to determine a sequence of tasks to be performed by the resource, the method comprising:

receiving data from a location measurement device associated with the resource, whereby to receive the actual location of the resource;

identifying, from a pool of scheduled and unscheduled tasks, a candidate task on the basis of location data associated with respective scheduled and unscheduled tasks and the actual location of the resource;

evaluating the identified task in relation to a next task associated with the resource in the schedule so as to select a task therefrom; and

issuing the selected task to the resource, whereby to modify the schedule of tasks.

A method as above, including identifying which of the candidate task and next task in the schedule has a higher priority, whereby to evaluate the identified task.

A method as above, further comprising monitoring data received from the location measurement device against an expected location, in which the method is triggered when the current actual location deviates from the expected location by more than a predetermined amount.

A method as above, including accessing the schedule so as to derive said expected location.

A method as above, further comprising verifying said actual location prior to issuing the selected task to the resource.

A method as above, including identifying the candidate task from a pool of allocated tasks.

A method as above, including receiving location derived from a Global Positioning Satellite (GPS) system, whereby to receive the actual location of the resource.

A method as above, in which the actual location of the resource is derived from a GPS system associated with a vehicle.

A method as above, in which the actual location of the resource is derived from a GPS system providing input to a terminal associated with the resource.

A method as above, further comprising receiving data from a further position determining system for use in verifying said data received from the location measurement device.

A computer-implemented system for issuing an unissued task to a resource, the resource having a plurality of allocated tasks associated therewith, the system comprising:

a storage system, the storage system holding location data indicative of an actual location of the resource and storing at least some of said plurality of allocated tasks as a sequence of issued tasks;

a processing system for reviewing task data indicative of tasks that are either scheduled or unscheduled and have not been issued to a resource so as to identify, from said task data, a task of a first type;

a location identifying component for identifying a location of the identified task of a first type; and

a query component for accessing the storage system so as to select at least one resource from a plurality of resources on the basis of a concordance between the identified task location and the actual location of respective ones of said plurality of resources,

wherein the processing system issues the identified task to the selected resource and updates the storage system to include the issued task for the selected resource.

A system as above, wherein the storage system stores issued tasks in association with an execution status, and the processing system selects the resource on the basis of the execution status of already issued tasks, whereby to select a resource.

A system as above, wherein the processing system selects the resource on the basis of a distance between said actual location and a location of a next issued task in the sequence, wherein the location of the next issued task is predetermined.

A system as above, wherein the task data further comprises issued tasks and the processing system is triggered to review the task data in response to notification of a task whose status has changed from issued to unallocated, the processing system selecting the at least one resource on the basis of concordance between temporal data associated with the respective tasks and temporal data associated with the unallocated task.

A system as above, wherein the task data includes priority information associated with a given task and the processing system identifies tasks of a predetermined priority, whereby to identify said task of the first type.

A system as above, wherein the processing system identifies said task of the first type on the basis of a relationship between the temporal data associated with the respective tasks and the current time, whereby to identify said task of the first type.

A system as above, wherein the storage system receives location derived from a Global Positioning Satellite (GPS) system, whereby to store the actual location of a resource for access by the processing system.

A computer-implemented system for modifying a schedule of tasks allocated to a resource, the system comprising:

a storage system holding schedule data indicative of a schedule comprising a list of tasks comprising a plurality of tasks to be used to determine a sequence of tasks to be performed by the resource and task data indicative of tasks unscheduled to any resource;

an interface for receiving data from a location measurement device associated with the resource, whereby to receive the actual location of the resource; and

a processing system for identifying, from the scheduled and unscheduled task data in the storage system, a candidate task on the basis of location data associated with respective scheduled and unscheduled tasks and the actual location of the resource,

wherein the processing system evaluates the identified candidate task against a next task scheduled for the resource so as to select a task therefrom and issues the selected task to the resource, whereby to modify the schedule of tasks.

A system as above, wherein the processing system identifies which of the candidate task and next task in the schedule has a higher priority, whereby to evaluate the identified candidate task.

A system as above, wherein the processing system monitors data received from the location measurement device against an expected location and triggers said identification of a candidate task when the current actual location deviates from the expected location by more than a predetermined amount.

A system as above, wherein the processing system accesses the schedule data so as to derive said expected location.

A system as above, wherein the processing system verifies said actual location prior to issuing the selected task to the resource.

A system as above, wherein the processing system identifies the candidate task from a pool of allocated tasks.

A system as above, wherein said data relating to said pool of tasks is stored in the storage system.

A system as above, wherein the storage system receives location derived from a Global Positioning Satellite (GPS) system, whereby to store the actual location of a resource for access by the processing system.

A computer-implemented system for issuing an unissued task to a resource, the resource having a plurality of allocated tasks associated therewith, the system comprising:

storage means for holding location data indicative of an actual location of the resource and storing at least some of said plurality of allocated tasks as a sequence of issued tasks;

means for reviewing task data indicative of tasks that are either scheduled or unscheduled and have not been issued to a resource so as to identify, from said task data, a task of a first type;

means for identifying a location of the identified task of a first type; and

selecting means for accessing the storage means so as to select at least one resource from a plurality of resources on the basis of a concordance between the identified task location and the actual location of respective ones of said plurality of resources,

wherein the selecting means issues the identified task to the selected resource and updates the storage means to include the issued task for the selected resource.

A computer-implemented system for modifying a schedule of tasks allocated to a resource, the system comprising:

storage means holding schedule data indicative of a schedule comprising a list of tasks comprising a plurality of tasks to be used to determine a sequence of tasks to be performed by the resource and task data indicative of tasks unscheduled to any resource;

means for receiving data from a location measurement device associated with the resource, whereby to receive the actual location of the resource; and

identifying means for identifying, from the scheduled and unscheduled task data in the storage means, a candidate task on the basis of location data associated with respective scheduled and unscheduled tasks and the actual location of the resource,

wherein the identifying means evaluates the identified candidate task against a next task scheduled for the resource so as to select a task therefrom and issues the selected task to the resource, whereby to modify the schedule of tasks.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of generating a schedule, the schedule comprising a plurality of tasks to be performed by a plurality of resources, at least some said resources having a plurality of allocated tasks associated therewith, the method comprising:
receiving data relating to the tasks to be performed and resources for allocating to said tasks;
receiving status data relating to tasks that have been issued to at least some of the resources;
receiving location data of a first type, said location data of the first type being a predetermined location;
receiving location data of a second type, said location of a second type including an actual location of a resource;
allocating resources to the tasks on the basis of location data of the first type or the second type;
in which the resources are selectively allocated to the tasks using the location of the second type in dependence on status data indicating completion of an allocated task.

2. A method according to claim 1, including selectively allocating resources to the tasks using the location of the second type in dependence on status data indicating completion of a plurality of allocated tasks.

3. A method according to claim 2, in which, for those resources in respect of which tasks are allocated on the basis of the location of the second type, the plurality of allocated tasks comprises a final task and a previous task, and the status data identifies the final task as completed.

4. A method according to claim 1, in which, for those resources in respect of which tasks are allocated on the basis of the location of the second type, some said resources are associated with a vehicle for travelling between tasks that have been allocated to the resources, and the method includes selectively allocating resources to the tasks using the location of the second type in dependence on status data identifying a non-transporting status of the vehicle.

5. A method according to claim 3 or claim 4, including interpolating between the location of the second type and a location of the first type associated with said previous task, and allocating the resources to the tasks on the basis of the interpolated location data.

6. A method according to claim 1, further comprising using the location of the second type to identify a location of the first type for the resource, in which resources are selectively allocated to the tasks on the basis of said location of the first type so identified.

7. A method according to claim 6, further comprising identifying overlap between the location of the second type for at least two said resources, whereby to identify said location of the first type.

8. A method according to claim 1, further comprising comparing the location of the second type with the location of the first type associated with a previously executed task for the resource so as to determine a variance in expected location, and identifying tasks within a predetermined distance from the location of the second type in the event that the determined variance exceeds a predetermined threshold.

9. A method according to claim 8, including evaluating the identified tasks against a cost function so as to determine whether or not to replace the next task in the plurality of tasks allocated to the resource with a said identified task.

10. A method according to claim 8, including identifying said tasks within a predetermined distance on the basis of respective priority status associated therewith so as to determine whether or not to replace the next task in the plurality of tasks allocated to the resource with a said identified task.

11. A method according to claim 8, in which the tasks within a predetermined distance comprise tasks allocated to a resource.

12. A method according to claim 8, in which the tasks within a predetermined distance comprise unallocated tasks.

13. A method according to claim 1, in which each said allocated task has a start time associated therewith, the method further comprising using the location of the second type to evaluate travel time to a next task in the plurality of allocated tasks, and to adjust the start time of the next task in the event that the evaluated travel time is different to a previously evaluated magnitude.

14. A method according to claim 6, in which each said allocated task has a start time associated therewith, the method further comprising using the location of the second type to evaluate travel time to a next task in the plurality of allocated tasks, and to adjust the start time of the next task in the event that the evaluated travel time is different to a previously evaluated magnitude.

15. A method according to claim 13, in which the travel time is evaluated on the basis of said location of the first type so identified.

16. A method according to claim 1, including receiving location derived from a Global Positioning Satellite (GPS) system, whereby to receive the actual location of a resource.

17. A method according to claim 4, in which the actual location of a resource is derived from a Global Positioning Satellite GPS system associated with the vehicle.

18. A method according to claim 16, in which the actual location of a resource is derived from a GPS system arranged to provide input to a terminal associated with the resource.

19. A method according to claim 1, in which the status data are received in a first process and said allocation of resources to tasks is performed in a second process, said first and second processes being asynchronous.

20. A method according to claim 19, in which the first process comprises storing said status data in a storage system and the second process comprises accessing the storage system to retrieve said status data.

21. A method according to claim 1, further comprising monitoring location data of the second type against an expected location for at least one of the plurality of resources, in which the method is triggered when the current actual location deviates from the expected location by more than a predetermined amount for said at least one resource.

22. A computer-implemented schedule generation system for use in generating a schedule, the schedule comprising a plurality of tasks to be performed by a plurality of resources, at least some said resources having a plurality of allocated tasks associated therewith, the schedule generation system comprising:
an interface for receiving data relating to the tasks to be performed and data relating to resources for allocating to said tasks, and for receiving status data relating to tasks that have been issued to at least some of the resources, wherein the data relating to the resources includes location data of a first type and location data of a second type, said location data of the first type being a predetermined location and said location of a second type including an actual location of a resource; and
a processing system for allocating resources to the tasks on the basis of location data of the first type or the second type,
wherein the processing system selectively allocates said resources to the tasks using the location of the second type in dependence on status data indicating completion of an allocated task.

23. A system according to claim according to claim 22, wherein the processing system selectively allocates resources to the tasks using the location of the second type in dependence on status data indicating completion of a plurality of allocated tasks.

24. A system according to claim 23, in which, for those resources in respect of which tasks are allocated on the basis of the location of the second type, the plurality of allocated tasks comprises a final task and a previous task, and the status data identifies the final task as completed.

25. A system according to claim 22, in which, for those resources in respect of which tasks are allocated on the basis of the location of the second type, some said resources are associated with a vehicle for travelling between tasks that have been allocated to the resources, and the processing system selectively allocates resources to the tasks using the location of the second type in dependence on status data identifying a non-transporting status of the vehicle.

26. A system according to claim 24 or claim 25, wherein the processing system interpolates between the location of the second type and a location of the first type associated with said previous task, and allocates the resources to the tasks on the basis of the interpolated location data.

27. A system according to claim 22, wherein the processing system uses the location of the second type to identify a location of the first type for the resource, and selectively allocates resources to the tasks on the basis of said location of the first type so identified.

28. A system according to claim 27, wherein the processing system identifies overlap between the location of the second type for at least two said resources, whereby to identify said location of the first type.

29. A system according to claim 22, wherein the processing system compares the location of the second type with the location of the first type associated with a previously executed task for the resource so as to determine a variance in expected location, and identifies tasks within a predetermined distance from the location of the second type in the event that the determined variance exceeds a predetermined threshold.

30. A system according to claim 29, wherein the processing system evaluates the identified tasks against a cost function so as to determine whether or not to replace the next task in the plurality of tasks allocated to the resource with a said identified task.

31. A system according to claim 29, wherein the processing system identifies said tasks within a predetermined distance on the basis of respective priority status associated therewith so as to determine whether or not to replace the next task in the plurality of tasks allocated to the resource with a said identified task.

32. A system according to claim 29, wherein the tasks within a predetermined distance comprise tasks allocated to a resource.

33. A system according to claim 29, wherein the tasks within a predetermined distance comprise unallocated tasks.

34. A system according to claim 32, in which each said allocated task has a start time associated therewith, and the processing system uses the location of the second type to evaluate travel time to a next task in the plurality of allocated tasks, and adjusts the start time of the next task in the event that the evaluated travel time is different to a previously evaluated magnitude.

35. A system according to claim 27, in which each said allocated task has a start time associated therewith, and the processing system uses the location of the second type to evaluate travel time to a next task in the plurality of allocated tasks, and adjusts the start time of the next task in the event that the evaluated travel time is different to a previously evaluated magnitude.

36. A system according to claim 24, in which the travel time is evaluated on the basis of said location of the first type so identified.

37. A system according to claim 22, wherein the interface receives location data derived from a Global Positioning Satellite (GPS) system, whereby to receive the actual location of a resource.

38. A system according to claim 44, wherein the interface receives location data derived from a Global Positioning Satellite GPS system associated with the vehicle.

39. A system according to claim 37, wherein the interface receives location data derived from a GPS system arranged to provide input to a terminal associated with the resource.

40. A system according to claim 41, in which the schedule generation system operates a first process and a second process, said first process comprising receiving the status data and said second process comprising allocating resources, wherein said first and second processes are asynchronous.

41. A system according to claim 40, further comprising a storage system for holding said status data for use by the processing system in the second process.

42. A system according to claim 41, wherein the processing system monitors location data of the second type against an expected location for at least one of the plurality of resources and allocates said resources to the tasks when the current actual location deviates from the expected location by more than a predetermined amount for said at least one resource.

43. A computer program, or a suite of computer programs, comprising a set of instructions to cause a computer, or a suite of computers, to perform the method according to claim 1.

44. A computer readable medium comprising the computer program of claim 43.

45. A computer-implemented schedule generation system for use in generating a schedule, the schedule comprising a plurality of tasks to be performed by a plurality of resources, at least some said resources having a plurality of allocated tasks associated therewith, the schedule generation system comprising:
means for receiving data relating to the tasks to be performed;
means for receiving data relating to resources for allocating to said tasks, wherein the data relating to the resources includes location data of a first type and location data of a second type, said location data of the first type being a predetermined location and said location of a second type including an actual location of a resource;
means for receiving status data relating to tasks that have been issued to at least some of the resources; and
allocating means for allocating resources to the tasks on the basis of location data of the first type or the second type,
wherein the allocating means selectively allocates said resources to the tasks using the location of the second type in dependence on status data indicating completion of an allocated task.
